(19) United States
(12) Patent Application Publication
(10) Pub. No.: US 2009/0128461 A1
(43) Pub. Date: May 21, 2009

(54) LARGE SCALE DISPLAY SYSTEM

(76) Inventors: William Scott Geldard, Queensland (AU); Peter Inglis, Queensland (AU); Scott Andrew Menzies, Queensland (AU); Dominic Michael Xavier, Queensland (AU)

Correspondence Address: YOUNG & THOMPSON, 209 Madison Street, Suite 500, ALEXANDRIA, VA, 22314, US

(21) Appl. No.: 12/088,531

(22) PCT Filed: Sep. 28, 2006
(86) PCT No.: PCT/AU2006/001421

§ 371 Date: Dec. 9, 2008

(30) Foreign Application Priority Data
Sep. 28, 2005 (AU) 2005905344
Apr. 13, 2006 (AU) 2006901956

(51) Int. Cl. G09G 3/34

(52) U.S. Cl. 345/84

(57) ABSTRACT

A large scale LED display system (12) is provided on a building structure (100). The system has a screen (12) formed of a number of side by side display panels (14) which may be foldable or rollable. Each panel has a number of equally spaced transparent polycarbonate tubes (80) which house pixel units (50) of LEDs (51) connected to printed circuit board (120) and a row controller (121) for controlling luminance of the LEDs. A bus member (54) convey power and video control signals from a panel controller (77) to each row controller. The panel controller has an initialising process adapted to allocate temporary addresses for the tubes and determine screen size accordingly. Video segments are extracted by the row controllers based on the addresses associated with the video control signals from the panel controller.

### BACKGROUND OF THE INVENTION

Large scale display systems are used to display live television broadcast events such as a game of sports or a stage entertainment performance, advertising and promotional materials, greetings at festive times, etc. Generally, light emitting diodes (LED) are arranged to form pixels which are controllable to provide images in a full range of visible colours. The display systems known to the applicant are formed of rigid display boards that are mechanically and electrically connected together. The connected boards are then supported on a rigid and sturdy support structure. The display boards must be mechanically and electrically connected together as a unit. The known display systems are therefore relatively heavy and bulky. As such, they are costly to transport and to assemble. These known systems are limited to a screen size of about 120m² due to structural and transportation limitations.

To support the known display system on a building, the system must be assembled on site and held in position by a lifting apparatus such as a crane, while being fixed to a wall of the building. Securing devices for supporting the system must be fixed to the wall. Invariably, there would be damage to the facade of the building. The secured display system would also block light from entering some windows on said wall of the building and hindering views through the windows.

The known display systems are provided in a range of fixed sizes. They are not flexible as they are not easily customised for a different screen size, nor can they be shaped into a non rectangular planar screen. Being rigid, they cannot be transformed to a curved screen.

Due to the high costs of transportation and assembly of the known display systems, they are uneconomical for short term use, such as during festive occasions, Christmas and New Years for example.

The prior art display systems have their LEDs arranged to form a matrix of equally spaced pixels. Electric power and control signals are carried along conductive wires connected to the LEDs. Accordingly, those system require a large number of wires and electrical connectors, which further add to their costs and weight. The number of wires and connections also result in a relatively long assembly time.

The LEDs of the prior art systems are fixed in a front viewing position. In full sunlight, the images formed by the LEDs are almost not viewable outdoor due to bright natural light.

When not operating, the prior art systems seems like a dark rectangle and are not aesthetic.

### OBJECT OF THE INVENTION

It is an object of this invention to provide a large scale display system which alleviates or reduces to a certain level one or more of the above disadvantages.

### SUMMARY OF THE INVENTION

In one aspect therefore the present invention resides in a large scale display system for displaying images. The system comprises a display screen formed of one or more foldable or rollable display panels, the or each said display panel having at least one display segment formed of intersecting conductive wires arranged in a matrix of rows and columns, and spaced pixel units supported by one or more of the wires in said rows or columns, or by one or more support lines extending along the or each said display panel, and the spaced pixel units being arranged to be controllably energisable pixels; a bus member arranged along one edge of the display screen or along one edge of the or each said display panel for conveying power and/or control signals to said wires; and a processor unit arranged to supply said control signals to the bus member(s) for controlling luminance of the pixels.

In another aspect therefore the present invention resides in a large scale display system for displaying images. The system comprises a display screen formed of one or more display panels, the or each said display panel having at least one display segment formed of spaced elongate members, each elongate member having a conductive carrier supported therein and spaced controllable pixel units mounted on said conductive carrier, the pixel units in the elongate members being arranged to form a matrix of pixels, a bus member arranged along one edge of the display screen, or along one or each of the opposed edges of the or each said display panel for conveying power and/or video data signals to said carriers; the bus member of the or each said display being in communication with a panel control unit arranged to supply said power and/or video data signals to the bus member(s) of the or each panel/segment for controllably energising said pixel units thereof to thereby controlling luminance of the pixels.

In one form, each elongate member has a video control unit arranged to, in response to the video data signals, controllably energise said pixel units therein. In an alternative form, the elongate members are arranged in at least one group of linked elongate members, and one of the linked elongate member in the or each group has a video control unit arranged to, in response to the video data signals, controllably energise said pixel units in the linked elongate members.

Preferably, said panel control unit(s) is configured to receive video signals from a video source and to transform the received video signals into modulated video data signals for conveying to the bus member(s). The video data may be superimposed on power for the pixel units.

The panel control unit(s) may have an initialisation arrangement for initialising the video control units in the elongate members to respond to the video data signals with corresponding addresses allocated to the elongate members. The initialisation arrangement may also be configured to determine screen or panel pixel size.

The display system in said another aspect may have a suspension arrangement for suspending said elongate members in a vertically or horizontally spaced direction. The suspension arrangement may include said one or more of the bus member(s) and/or one or more suspension lines extending along the or each said display panel. As the bus member(s)/suspension lines are relatively flexible, the display panels are foldable or rollable.

Desirably, each said bus member and/or each said suspension line is associated with a plurality retention clips, each of which being configured to retain an elongate member received therein. It is preferred that the clips are arranged to be pivotally movable so that orientation of the elongate members can be selectively positioned.

In preference, the display screen is formed of two or more of said display panels arranged side by side, and adjacent display segments of the side by side display panels may be arranged to be interconnectable. Thereby, the size of the display screen is selectively configurable. The elongate members may be formed with end flanges shaped so that one end of each elongate member in a display panel can be interconnected with an adjacent end of a corresponding elongate member in an adjacent display panel. Alternatively, a coupling member may be provided for interconnecting adjacent ends of side by side display panels.

The conductive carrier in each elongate member may be formed of a flexible or rigid material. Preferably, it is formed as a circuit board having one or more control circuit modules for the corresponding pixel units.

In preference, the display system has a heat transfer arrangement adapted to transfer heat from the conductive carrier in each elongate member to exterior thereof. In one form, the heat transfer arrangement has a heat sink element fixed to each elongate member and one or more fixing elements made of a heat conductive material are adapted to fix the heat sink element to the associated elongate member and to transfer heat from said conductive carrier to the heat sink element.

Typically, the bus member(s) are arranged to carry control signals so that the control circuit modules on the conductive carriers connected thereto can control luminance of the LEDs in accordance with the control signals.

The bus member(s) may also be arranged to carry an AC power source injected with control signals for the pixel units, and the control circuit modules are arranged to transform the AC power source into a DC power source for use by the pixel units to energise the LEDs, and to filter the control signals for controlling luminance of the LEDs.

Each elongate member may be formed with a hollow extending therethrough and bounded by a base, a rear wall, an open front or substantially transparent front wall, and a top section. The conductive carrier is mounted in the hollow and the pixel units are arranged for the LEDs facing said an open front or substantially transparent front wall. Preferably, the pixel units are positioned so that the LEDs are at a distance from said an open front or substantially transparent front wall. As such, minimal sunlight falls directly onto the LEDs.

The top section of each elongate member may have a top plate arranged to be removable. This is beneficial where the top plates are used as a sign board as the sign can be easily changed. Preferably, the top section of each elongate member is formed with facing grooves for removably receiving its top plate. One of said grooves is formed in a flange which extends forward of said open front or substantially transparent front wall. This flange, thus, serves as a sun light shield for the LEDs.

It is preferred that the each elongate member has a light shield extending from said open front or substantially transparent front wall. More preferably, the elongated members are arranged to be controllably adjustable in orientation so that they can be adjustably positioned depending on the angle of incident sunlight.

Preferably, said connector members are of an insulation piercing type having a conductor element arranged to penetrate into an insulation about the adjacent wires to be connected so that connection can be made relatively quickly.

In preference, the or each said display panel has a plurality of display segments arranged in an array, and adjacent display segments in said array are mechanically and/or electrically connected to each other. Where the adjacent display segments in said array are mechanically connected said adjacent segments are electrically isolated from each other.

Each of said one or more support lines may be a steel cable arranged to support the pixel units.

The display screen may have a top, a bottom and opposed sides, and the bus member may be arranged along either the top or bottom, or one of the opposed sides. Desirably, the bus member is arranged along one of the opposed sides, and the or each column of the display segment(s) may be constituted by a single conductive wire arranged to supply control signals to each of the pixel units connected therewith. More desirably, each row includes a signal path connected between the bus member and the single conductive wire in each column, thereby control signals are conveyed from the bus member to the conductive wires in the columns.

The system may have a decoding arrangement for decoding the control signals into decoded signals and the decoding arrangement is arranged to provide the decoded signals to control said luminance of the pixels. Preferably, the decoding arrangement includes a decoder for each row of the wires. The decoders may be arranged along the bus member or incorporated in the pixel units.

Each of the pixel units may have one or more controllable light emitting diodes (LEDs). Preferably, each said pixel unit has a red LED, a green LED and a blue LED, and the processor unit is arranged to produce control signals that can control the LEDs in the pixel units to produce luminance over a substantially full range of colour spectrum.

In preference, each pixel unit has a housing configured to house said one or more LEDs. The housing may have an open front and a reflector configured to reflect light rays from the LEDs through substantially parallel paths through the open front. A cover configured as a lens may be arranged at the open front. Preferably, the pixel units are arranged to be water proof.

The housing may also have electrical connection means for connecting the intersecting wires to the LEDs. Preferably, the connection means include connectors of the insulation piercing type so that connection to the wires can be made in a relatively quick time.

The display system may further include a sway restraining arrangement for limiting sway of said display screen. In one form the sway restraining arrangement may have a number of spaced releaseable securing members for securing the display screen to a support structure. Preferably, the releaseable securing members are associated with certain pixel units so that the substantially whole display screen is limited from swaying. The releaseable securing members may be in the form of ties for tying to parts of the support structure, or suction devices for fixing to relatively smooth surfaces of the support structure.

The display system may also include a support arrangement for supporting said display screen on a support structure. The support arrangement may include a set of brackets configured to be releaseably fixed to the support structure and to support the top of the or each unfolded or unrolled display panel of the display screen. Alternatively, the or each display panel may have its top fixed to a roll and the support arrangement may have a spindle extending through the roll or rolls and arranged to turn said roll(s) so the display panel(s) can be retracted on said roll(s) for storage or transportation, and extended during use. A drive arrangement may be associated with the spindle to facilitate turning of said roll(s). The drive arrangement may include a controllable electric motor coupled to drive said spindle.

The support arrangement may also include a suspension cable arranged to suspend the display screen.

The top, bottom and the opposed sides of the display screen may be shaped to conform to a particular shape of the support structure.

The pixel units are preferably arranged to form a pixel pitch ranging from about 25 mm to about 100 mm depending on expected viewing distance.

The display screen thus provides a partial transparency due to the relatively large space or pitch between the pixel units, and the use of conductive wires to support the pixel units, as well as to carry power and control signals. The arrangement enables through viewing for people looking out a window in a building serving as the support structure. Wind loading is also relatively low due to the large spaces between the pixel units. Being rollable or foldable, the display screen is bendable to conform with the shape of the support structure. Accordingly, it can be used on a non flat support structure. The display panels can be stored in rolls and transported to a location, such as a multistory building, where they can be unrolled for a short term use.

### BRIEF DESCRIPTION OF THE INVENTION

In order that the present invention can be more readily understood and be put into practical effect reference will now be made to the accompanying drawings which illustrate one preferred embodiment of the invention and wherein:

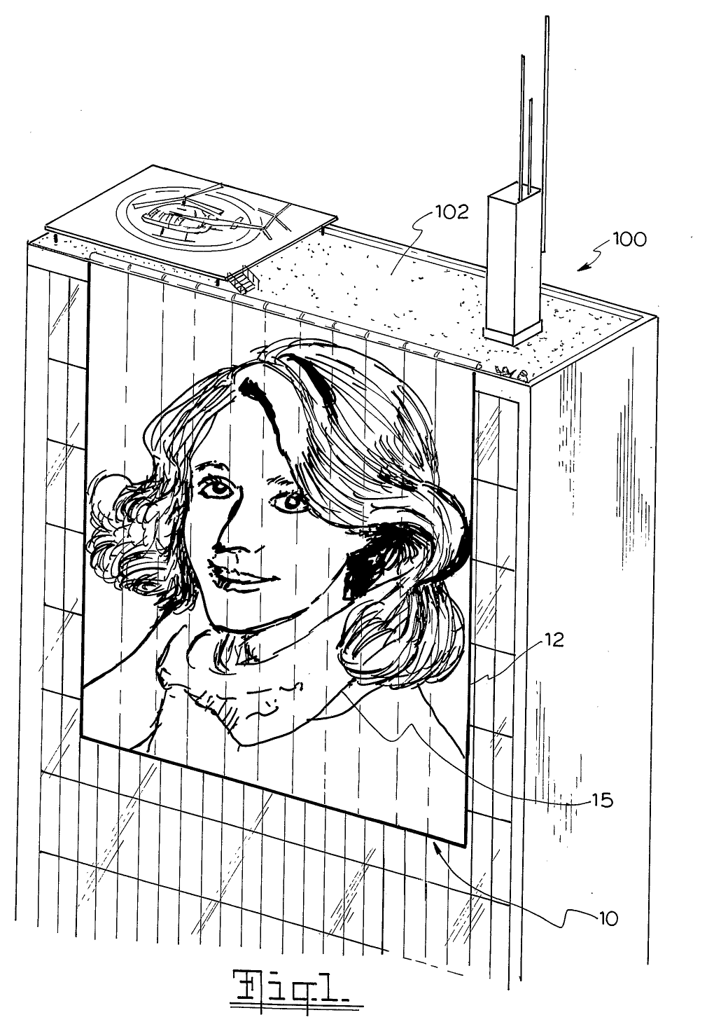

FIG. 1 schematically illustrates an embodiment of the large scale LED display system according to the present invention supported on a multistory building;

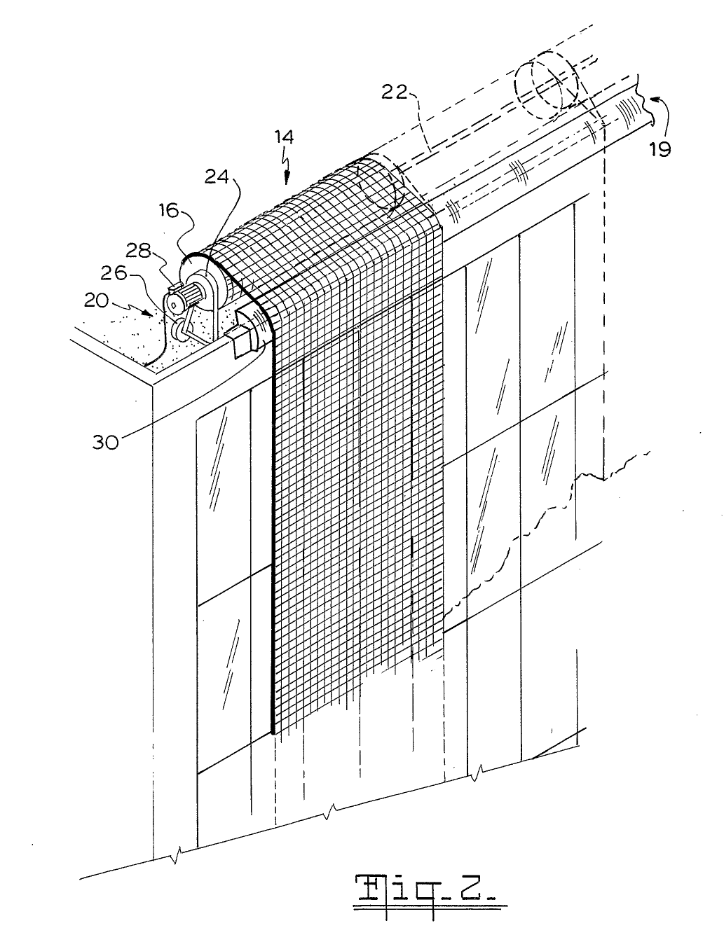

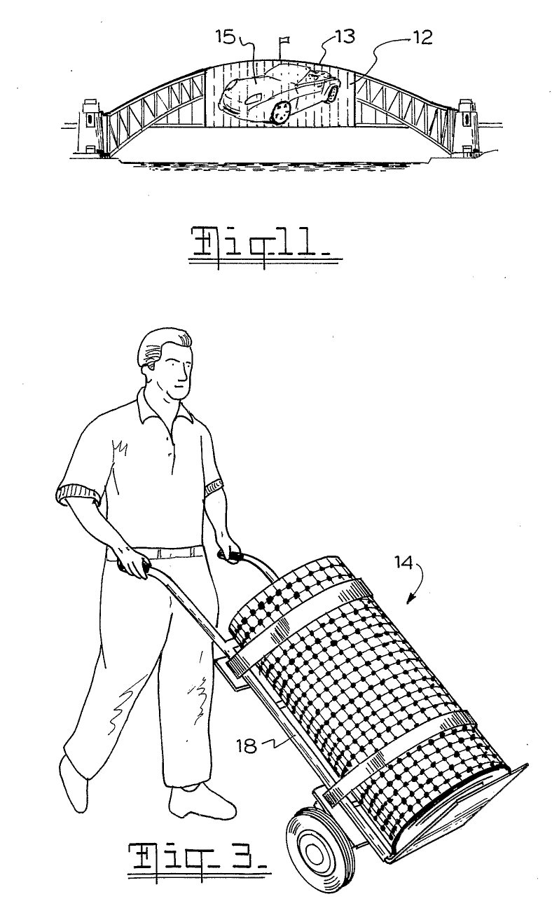

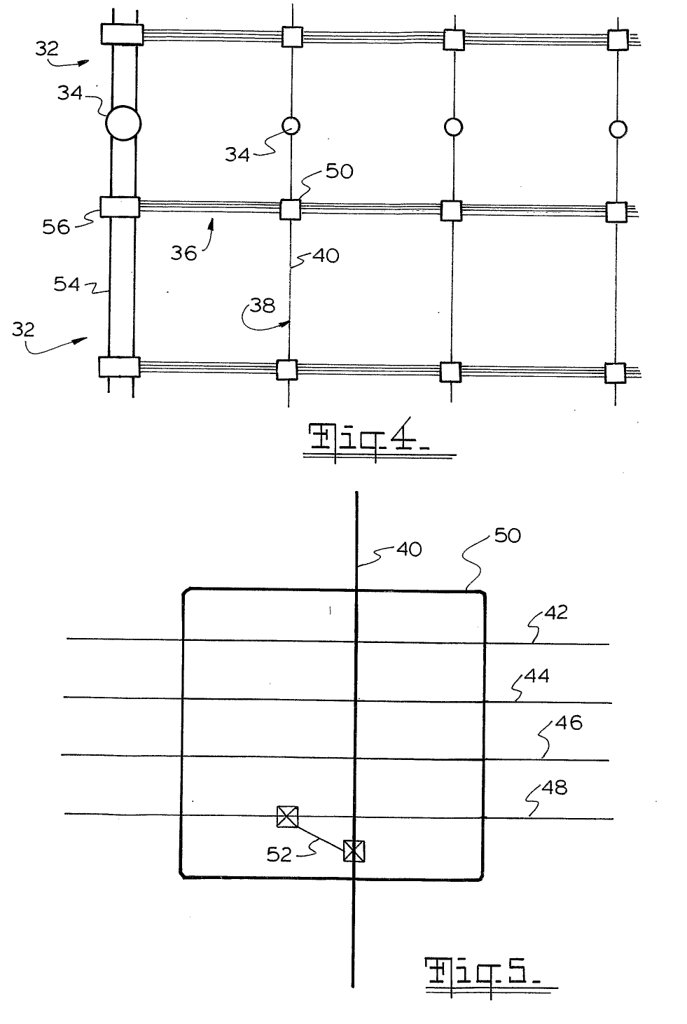

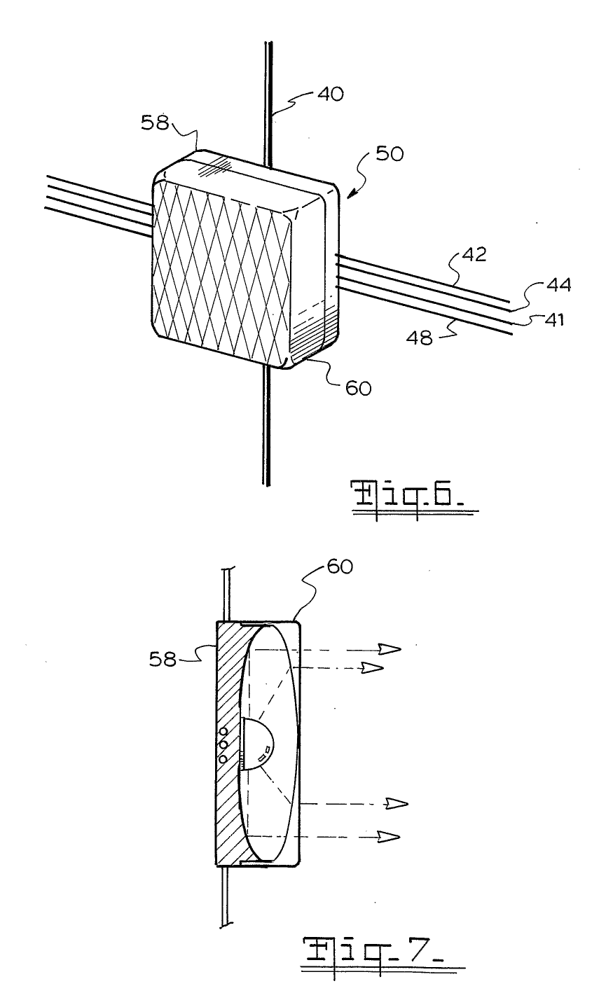

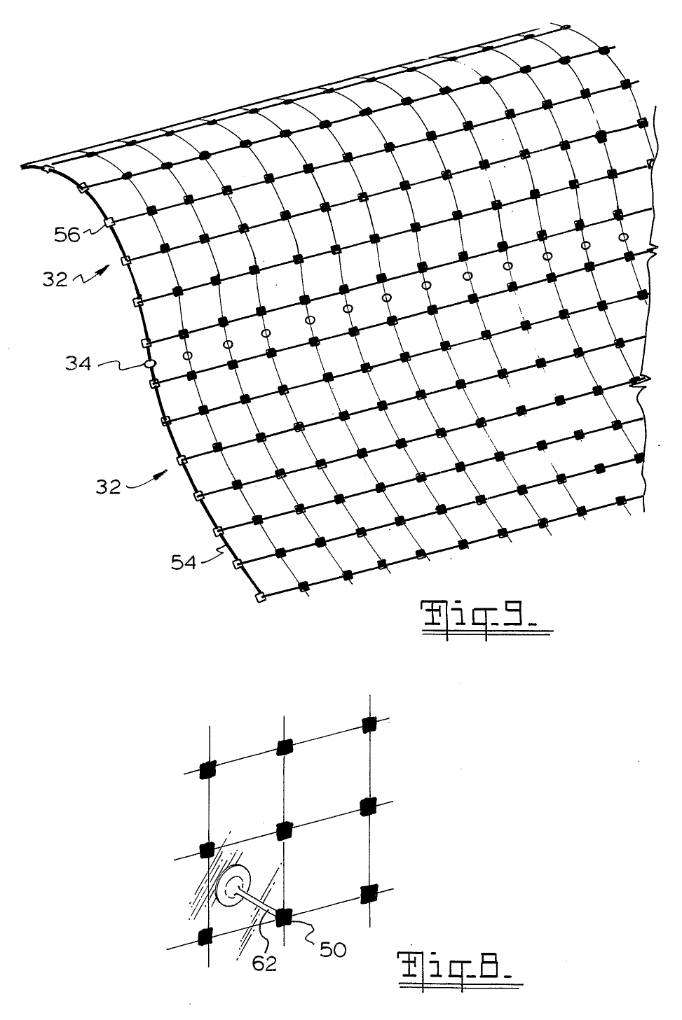

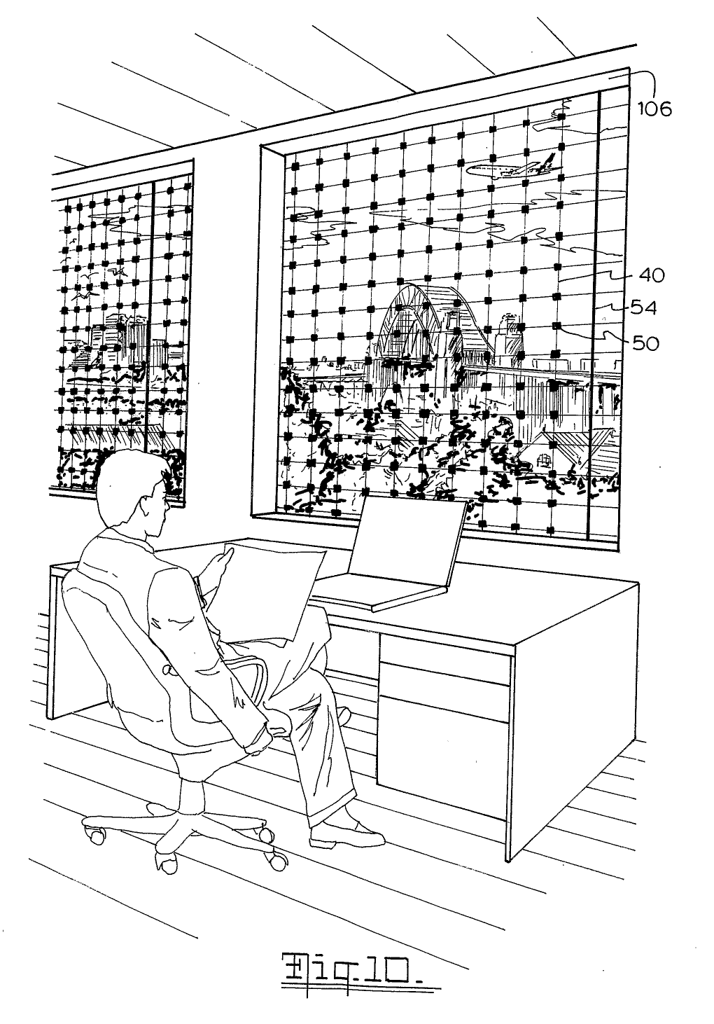

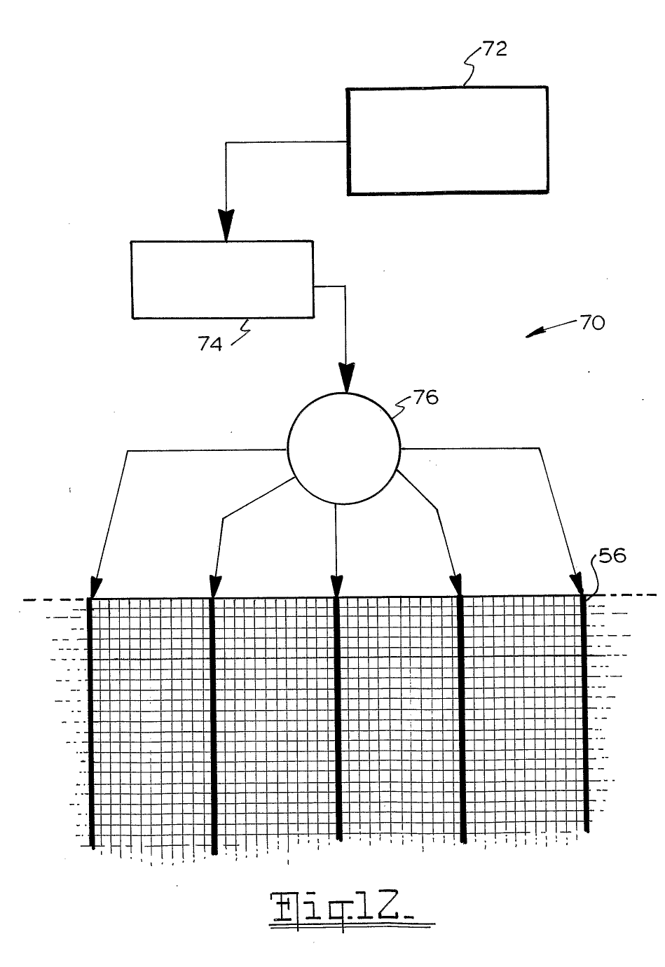

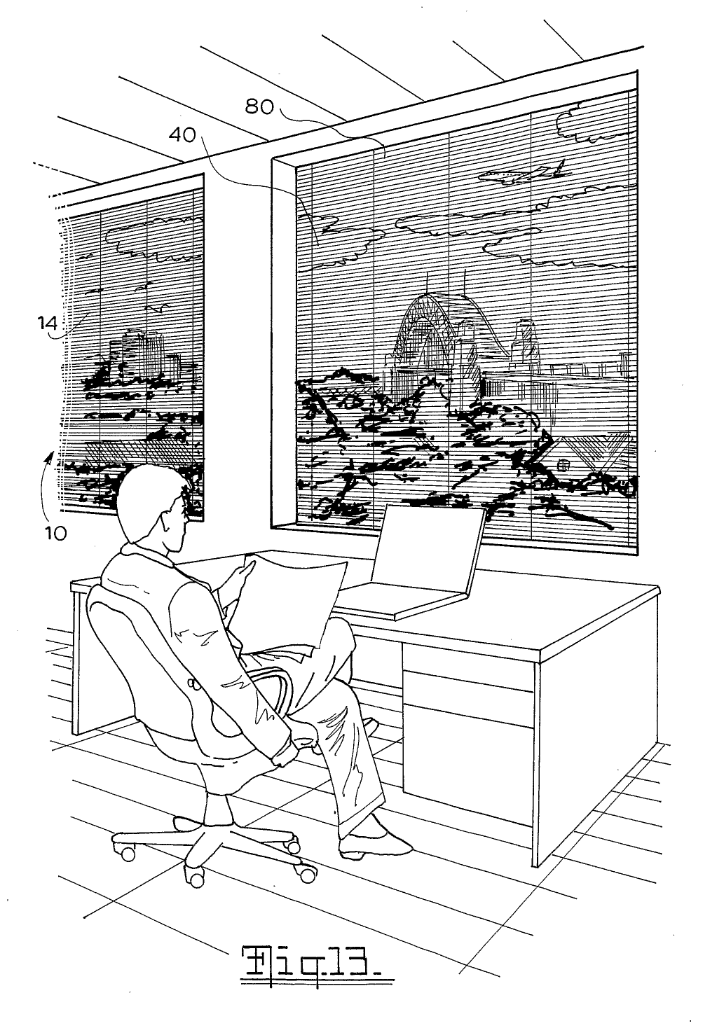

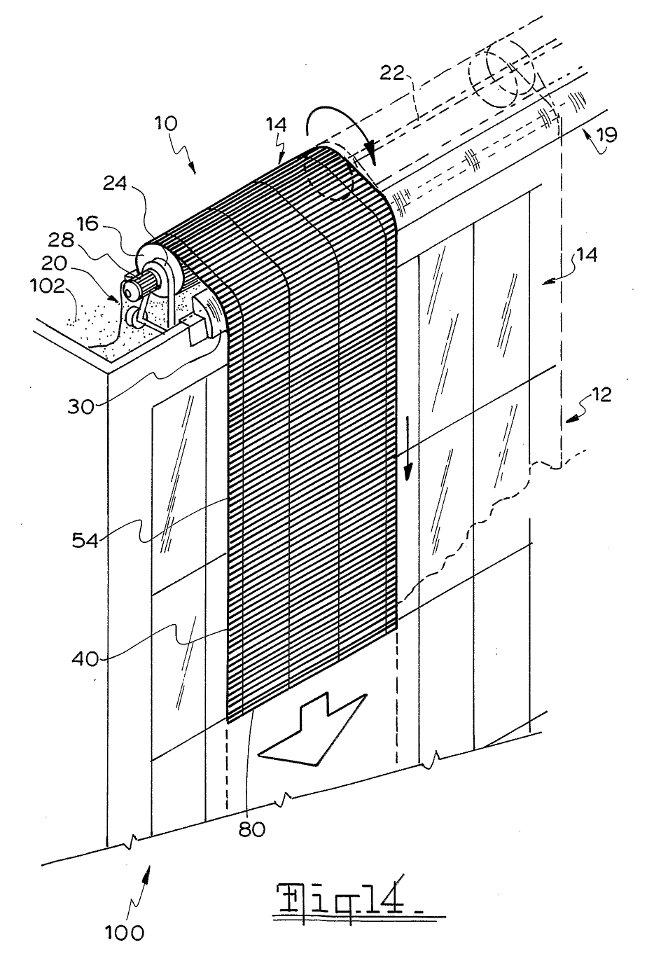

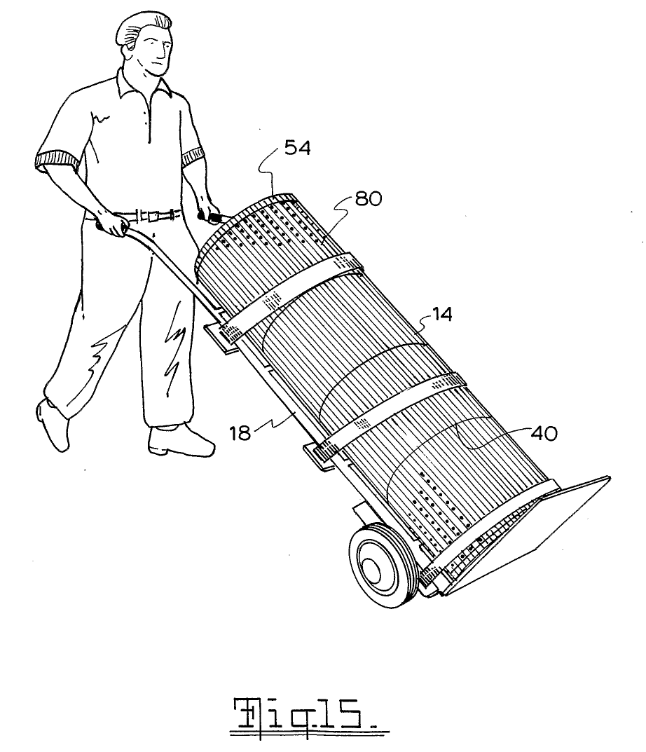

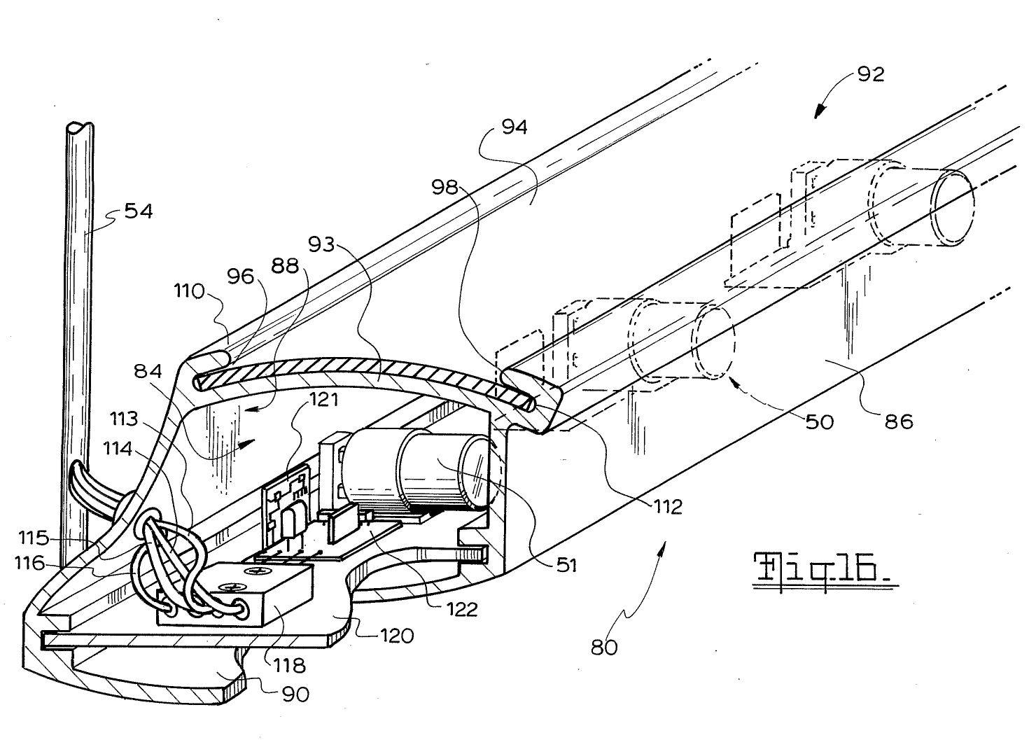

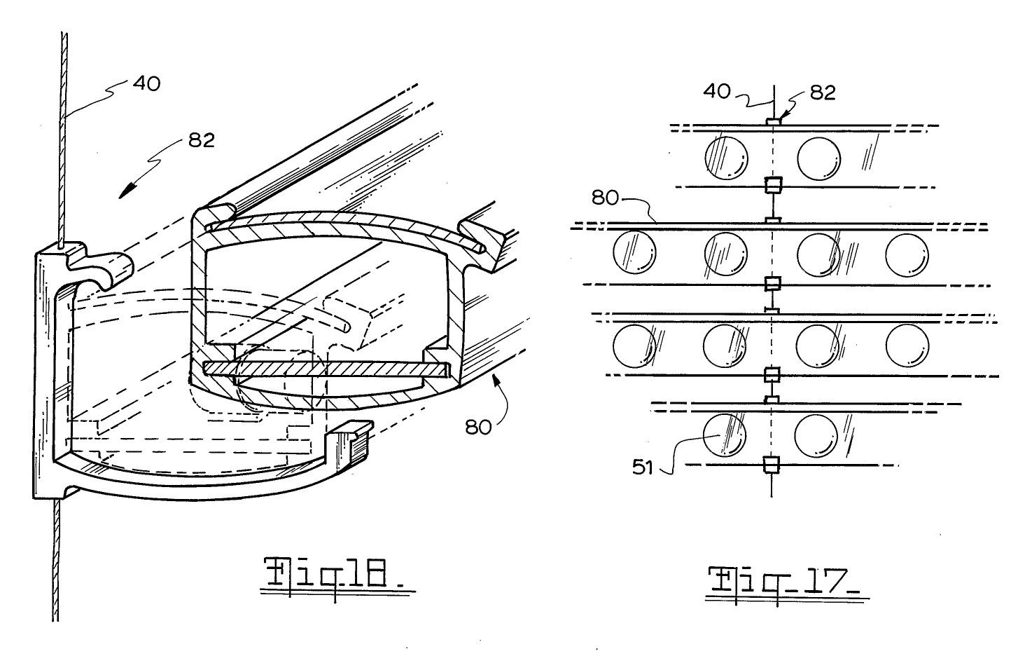

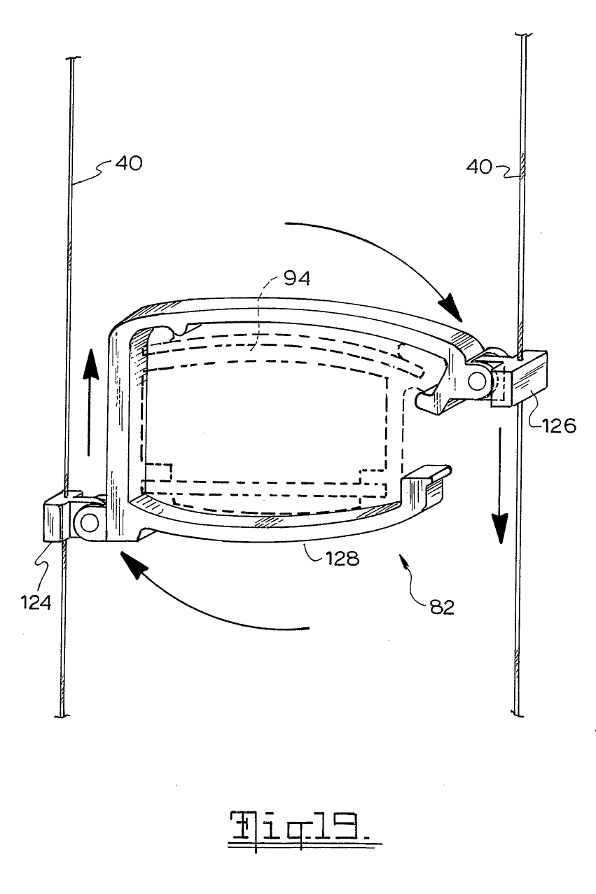

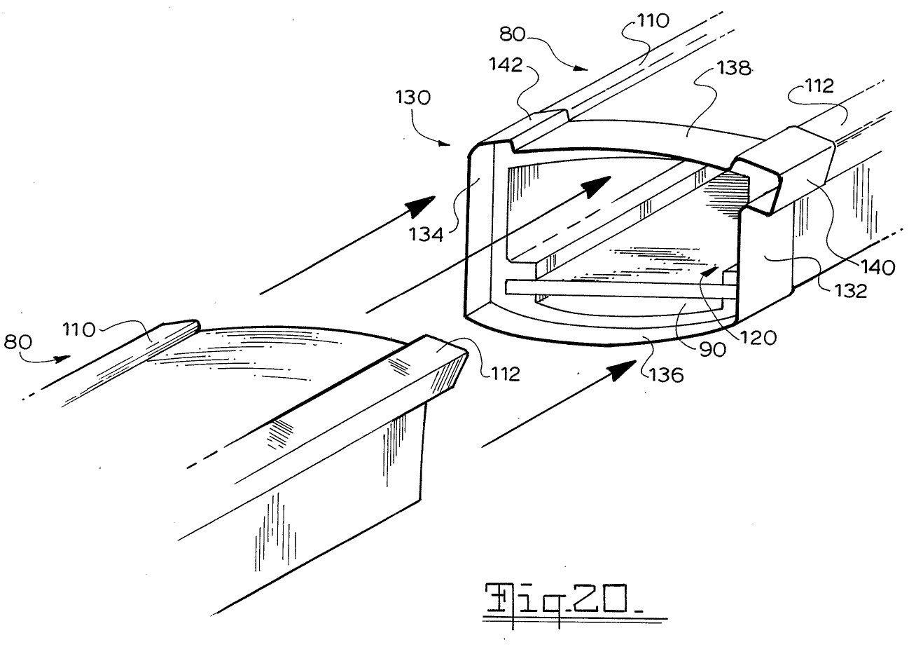

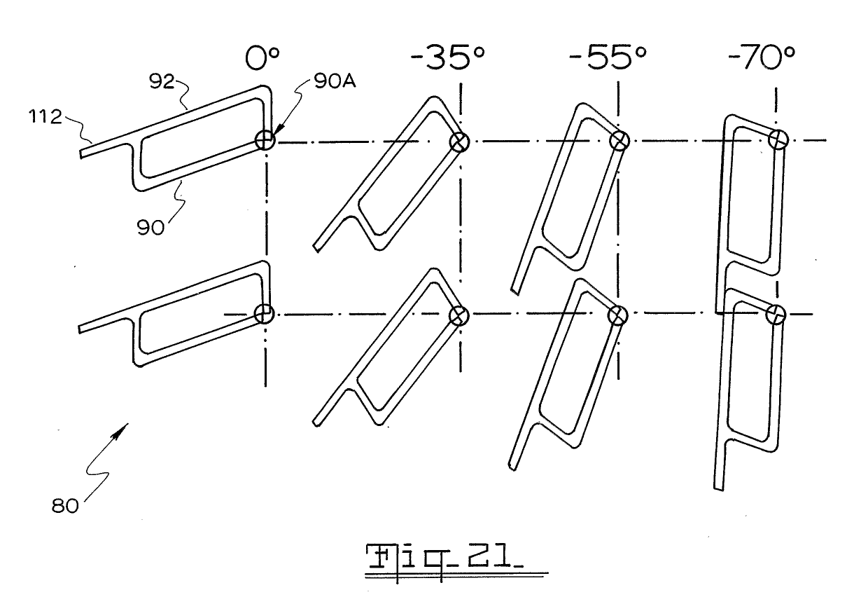

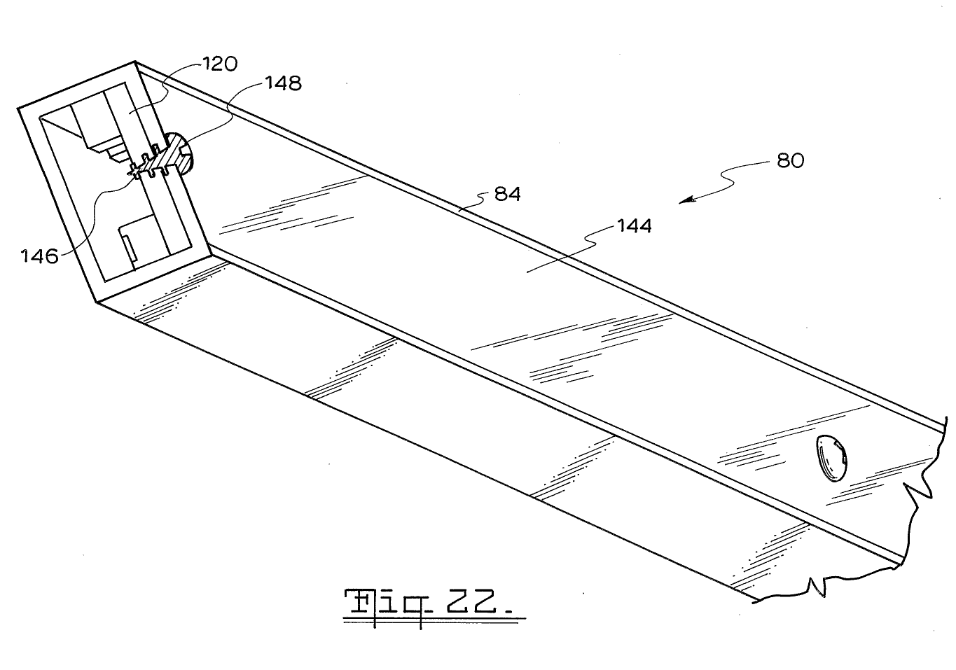

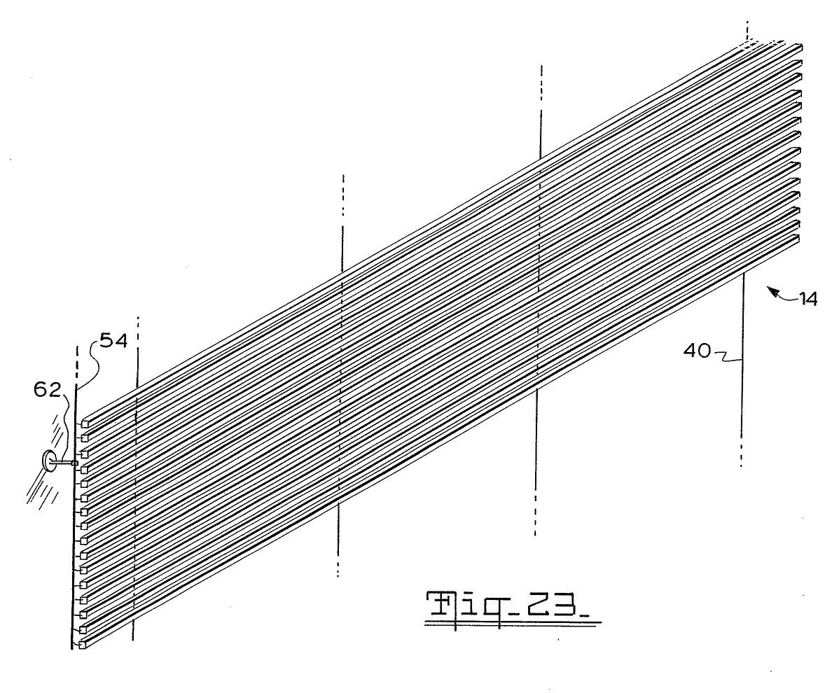

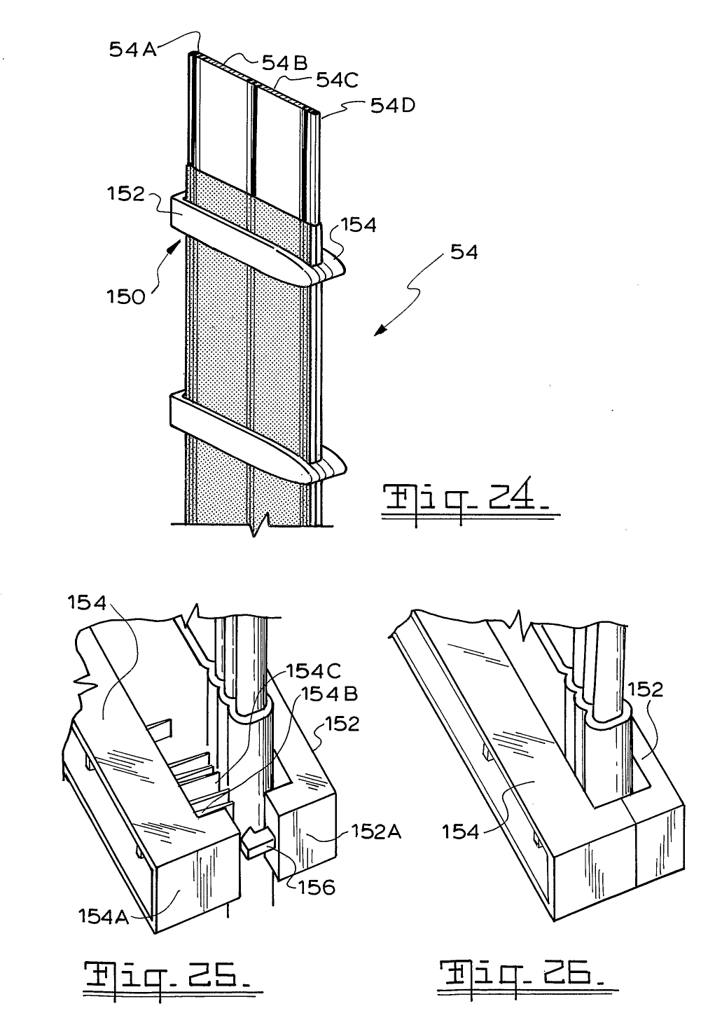

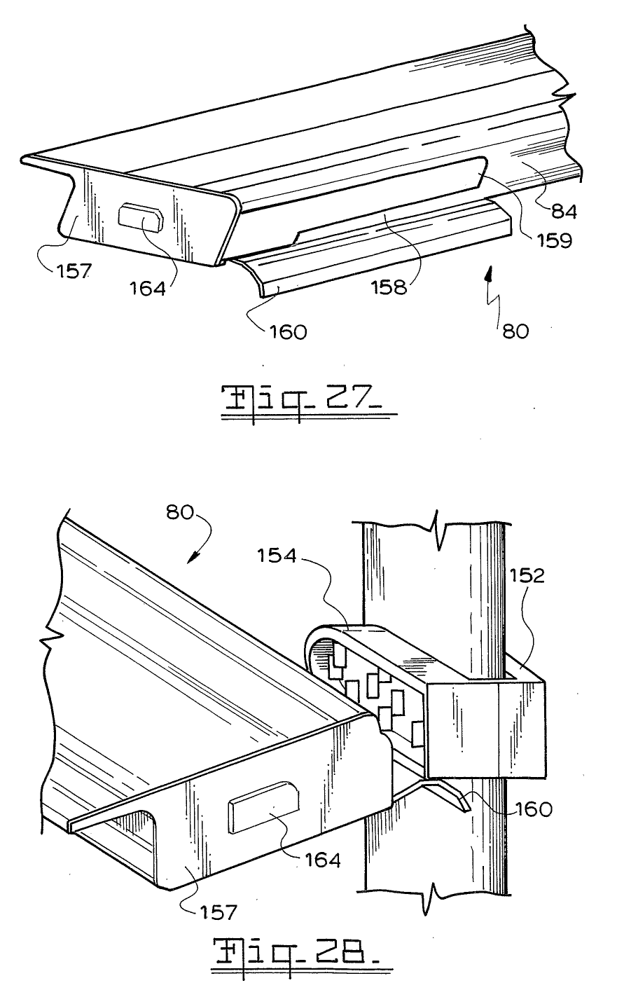

FIG. 2 is a partial view showing a matrix of wires in a display panel of the system shown in FIG. 1;

FIG. 3 is a perspective view showing a roll of the display panel being wheeled on a trolley;

FIG. 4 is a partial view showing the details of the display panel;

FIG. 5 shows the wire connections to a particular pixel unit of the display panel;

FIG. 6 is perspective view of a pixel unit of the display panel;

FIG. 7 is a cross section view of the pixel unit shown in FIG. 6;

FIG. 8 shows a form of the sway limiting device for the system according to the present invention;

FIG. 9 is partial view illustrating a curved section of the display panel;

FIG. 10 shows a view through a window of the building where the display system of FIG. 1 is supported;

FIG. 11 shows another embodiment of the display system according to the present invention;

FIG. 12 shows a signal control arrangement for the display system according to the present invention;

FIG. 13 is a view through windows of a building installed with a further embodiment of the large scale LED display system according to the present invention;

FIG. 14 is a partial view showing the process of installing display panels of the system shown in FIG. 13;

FIG. 15 is a perspective view showing a roll of the display panel of the system shown in FIG. 13 being wheeled on a trolley;

FIG. 16 is a partial cut-away perspective view showing the details of an elongate member in the display panel;

FIG. 17 is a schematic partial view of a matrix of pixels formed by the pixel units of the display panel;

FIG. 18 is partial perspective view showing a suspension arrangement for the elongate members of the display panel;

FIG. 19 is partial perspective view showing another form of the suspension arrangement for the elongate members of the display panel;

FIG. 20 is partial perspective view showing facing ends of the corresponding elongate members of adjacent display panels;

FIG. 21 is a schematic end section view showing adjacent elongate members in four rotational positions;

FIG. 22 is a partial schematic perspective view showing a form of the elongate member associated with a heat sink element;

FIG. 23 shows a form of the sway limiting device for the system shown in FIG. 13;

FIG. 24 is a partial perspective view of one form of the bus member with spaced insulation piecing connector assemblies;

FIG. 25 shows one connector assembly shown in FIG. 25 with its snap fitting components separated;

FIG. 26 shows the snap fitting components in FIG. 26 in the assembled state;

FIG. 27 is a partial perspective of another form of the elongate member provided with a slot in its rear wall for receiving connectors from the circuit board;

FIG. 28 shows the elongate member shown in FIG. 28 to be connected to one connector assembly;

FIG. 29 shows one form of the locating engagement arrangement for inter engaging adjacent elongate members in alignment;

FIG. 30 shows a signal control arrangement for the display system shown in FIG. 13;

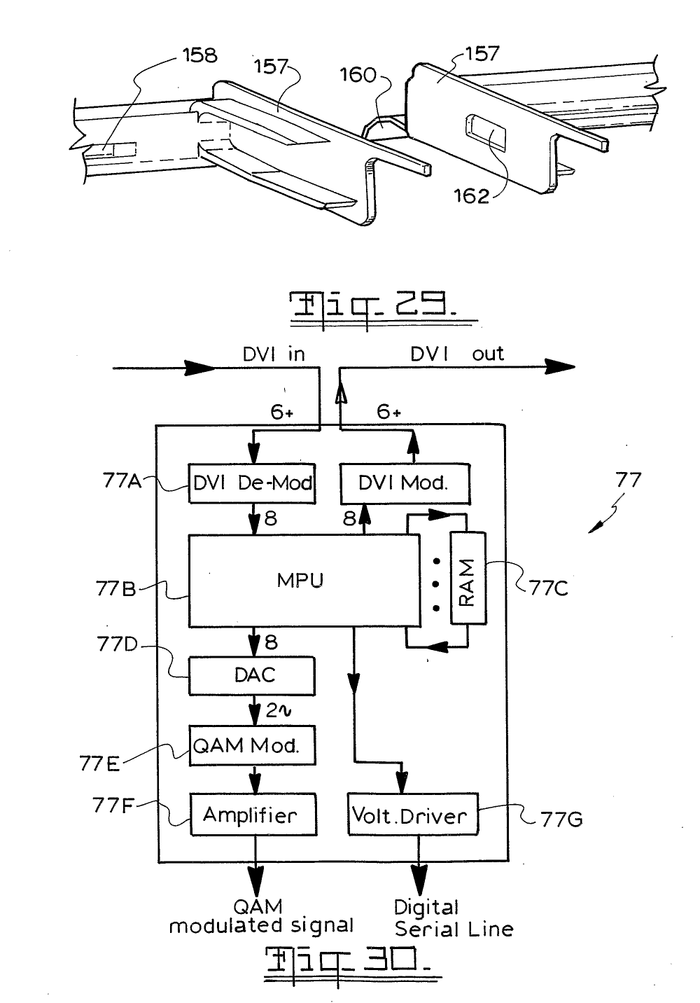

FIG. 31 is a schematic diagram showing main components for video signal processing;

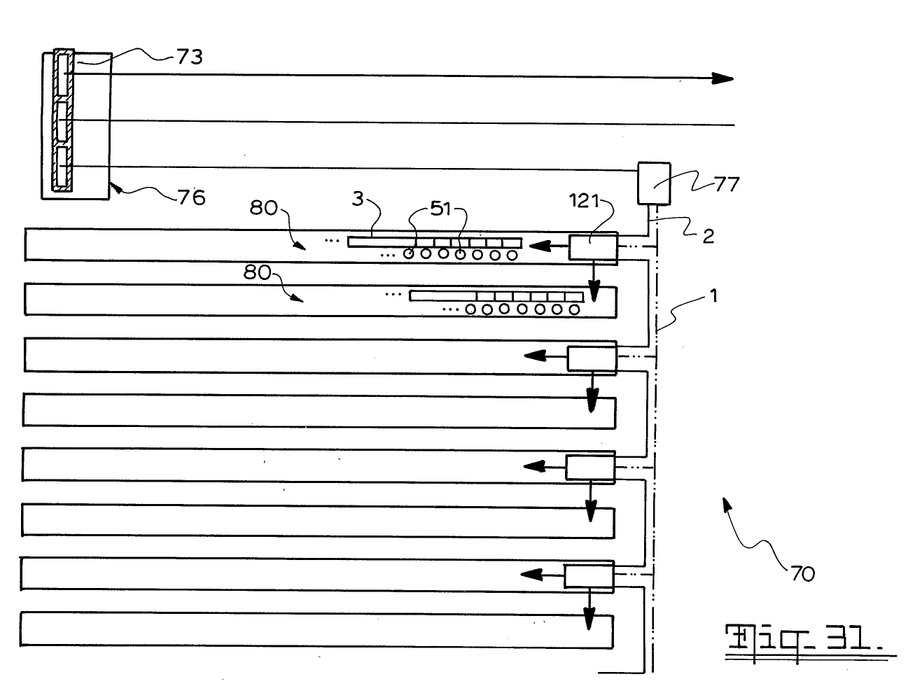

FIGS. 32 and 33 are block diagrams showing respectively certain components in the panel controller and the row controller; and

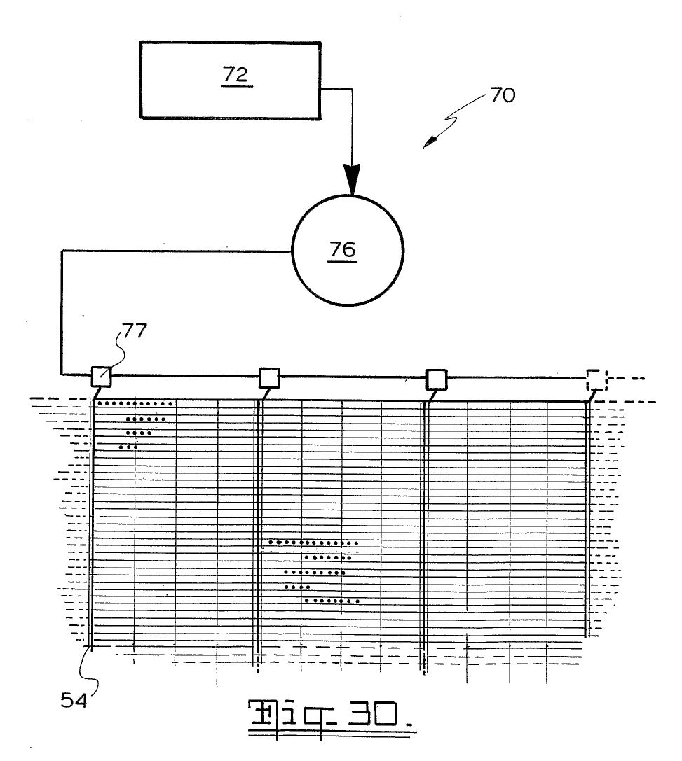

FIGS. 34 to 41 show the status of the row controllers at various steps in operation.

### DETAILED DESCRIPTION OF THE INVENTION

Referring to the drawings and initially to FIG. 1 there is shown an embodiment of the large scale LED display system 10 according to the present invention. The display system 10 is supported on a multistory building 100, and it extends over a substantial part of an external surface of the building 100. As shown, the display system 10 is supported on the roof 102 and extends downward over multiple levels of the building 100.

The display system 10 has a display screen 12 formed of a number of interconnected side by side display panels 14 (see FIG. 2). Each of the panels 14 can be rolled about a drum roll 16 during storage or for transportation. The rolled display panels can thus be easily moved from one location to another location. FIG. 3 shows one display panel 14 secured to a wheeled hand trolley 18 that is wheeled by a worker, as one example of transportation. Referring again to FIG. 2, the display panels 14 are supported by a suspension arrangement 19. The suspension arrangement 19 has a stand 20 with a spindle 22 extending between two end supports 24 (one only shown) on rollers 26. An electric motor 28 is coupled to the spindle 22. The motor 28 operates to extend and retract the display panels 14. A curved protective member 30 extends along the roof edge where the panels 14 are to be lowered.

Each display panel 14 is formed of an array of display segments 32 (see FIGS. 2 and 9) that are mechanically connected together by couplings 34. Each segment 32, as shown in FIG. 4, has rows 36 and columns 38 of conductive wires. In this embodiment, each column 38 has a single signal wire 40, and each row 36 has three wires 42 to 46 supplying power to the red, green and blue LEDs in pixel units 50 on that row and a signal conveying wire 48 connected to the column signal wire 40 by a link connection 52 (see FIG. 5). A bus 54 is provided along one side of the display screen 12. The bus 54 has a decoding unit 56 connected to the wires in each row 36. The decoding units 56 are arranged to decode video control signals addressed to the pixel units 50 in particular rows, and to supply power and the decoded signals to said pixel units 50. Alternatively, the pixel units 50 may incorporate a decoder (not shown) for decoding the control signals, and the boxes referred to as 56 are connectors for connecting the wires to the bus 54.

Referring to FIGS. 6 and 7, each pixel unit 50 has a housing 58 in which the three LEDs are fixed and connected to the column wire 40 and the row wires 42 to 46. The housing 58 is shaped so that light from the LEDs are reflected towards its open front face which is covered by a lens 60. The lens 60 and/or the housing 58 may be configured to either increase viewing angle or to concentrate light output to a particular direction. The column wires 40 are relative larger than the row wires as they are also arranged for supporting the pixel units 50. Alternatively, a translucent cover may cover the open front face.

The system 10 has a sway limiting arrangement 62 for limiting sway of the display panels 14. FIG. 8 shows one form of the sway arrangement 62 which are suction devices connected to certain pixel units 50 for fixing to a smooth surface such as a wall or glass on a window.

The display panels 14 can be used on a non-flat structure as they can curve to conform to the shape as shown in FIG. 9.

As the pixel units 50 in this embodiment are spaced at a substantial distance (>50 mm) and supported by the column wires 40, the display screen 12 allows substantially full view through windows 106 in the building 100 as shown in FIG. 10.

The display screen 12 can be arranged to conform to the shape of a support structure. As shown in FIG. 11, the screen 12 has a curved top 13.

The control bus 54 of each display panel 14 is arranged to receive power and control signals for powering and controlling the LEDs of the pixel units 50 to display images 15 such as shown in FIGS. 1 and 11. The control signals are decoded by the decoding units 56 or the decoders in the pixel units 50. The decoded signals then control luminance of the LEDs to form images. To this end, a signal processing arrangement 70 is used to provide the power and the control signals to the bus 54 (see FIG. 12). The processing arrangement 70 includes a signal processing unit 74 arranged to receive video signals from a video source 72 and process the video signals to produce control signals that are communicated to a distributor 76 for distributing the control signals to the appropriate bus 54. The control signals are then decoded by the decoding units 56 or the decoders in the pixel units 50.

Turning now to the further embodiment of the system shown in FIG. 13, the large scale LED display system 10 is supported on a multistory building 100 (see FIG. 14), and it extends over a substantial part of an external surface of the building 100. The display system 10 is supported on the roof 102 and extends downwardly over multiple levels of the building 100. A person in the building is able to enjoy outside view through windows over which the screen 12 of the display system 10 extends.

The display system 10 has a display screen 12 formed of a number of interconnected side by side display panels 14. Each of the panels 14 can be rolled about a drum roll 16 for storage and transportation as hereinbefore described.

Referring again to FIG. 14, the display panels 14 are supported on a suspension arrangement as hereinbefore described with reference to FIG. 2, with the exceptions that the bus member 54 in this embodiment also optionally serves as a suspension member together with the spaced load bearing suspension lines or wires 40. In this embodiment, the bus member is arranged inwards of the left edge of each of the display panels 14. The display panels 14 in this embodiment has a number of vertically spaced parallel elongate members 80 retained in position by clip members 82 which are spacedly fixed along the suspension lines 40 and the bus member 54 (see FIG. 18). The elongate members 80 are equally spaced and each elongate member 80 is formed, as shown in FIG. 16, as a transparent tube with a longitudinal hollow 84 which is bounded by a front wall 86, a rear wall 88, a base 90 and a top section 92. The top section 92 has a removable top strip 94 retained in grooves 96 and 98 formed in respective flanges 110 and 112 at the top section 92. The flange 112 is configured so that it extends over the front wall 86 to serve as a shield for the LEDs. While not shown, the inventors contemplate a controllably movable shield for shielding the LEDs so that the extent of the shield over the front wall 86 is automatically adjusted in dependence of the angle of incidence of the sun ray, or time of day/season.

The strips 94 are made of non transparent material and act as a sun shade for the LED pixel units 50 arranged in the hollow 84. Alternatively, the top section 92 may have a top wall 93 which may be painted so as to serve as a sun shade for the pixel units 50. The shade strips 94 also act as an advertising or promotional material for which each strip 94 forms a narrow slice of the overall advertisement or promotional sign. As the strips 94 are removable the sign can be changed to suit a particular promotion or advertisement.

The bus member 54 is connected by wires 113 and 114 to a connection terminal 118 for supplying power and control signals to the LED pixel units 50. A pair of further wires 115 and 116 are provided for conveying video data signals to a following slave elongate member. For this purpose, each elongate member 80 has a circuit board 120 with a video control unit 121 for decoding the video data signals and providing the decoded video data signals to control modules 122 of the pixel units 50 therein. The connection terminals 118 thus covey power and control signals along conductive tracks (not shown) on the circuit board 120 to the video control unit 121 and the modules 122 for controlling luminance of the LEDS 51 of the pixel units 50. The video control unit 121 also provides the demodulated video data signals to any slave elongate member 80 on the wires 115 and 116.

Accordingly, power is delivered by conductor wires 113 and 114 connected to the master elongate members or tubes 80 and the bus members 54. The wires 115 and 116 relay power and the decoded video signals to slave tubes 80. In an alternative, the bus members 54 may form the suspension mechanism in its entirety. The power is delivered at a nominal voltage of 48 volts and reduced to lower DC voltages with a power transforming circuitry in the control unit 121. The control signals for the pixel units 50 may either be injected onto the AC power cables at the controller and filtered out on the tube electronics, or via additional conductors or fibre (not shown) from the controller to tube electronics.

The LEDs 51 thus form pixels of the screen 12 as partially shown in FIG. 17.

FIG. 19 shows a form of the clip members 82 which cause the elongate members 80 to be selectively tiltable to present the advertising sign on the strips 94 for viewing in front of the display 12 or for adjusting screen orientation. The clip member 82 as shown has a pair of fixing elements 124 and 126 for fixing to respective suspension wires 40, and a clip element 128 pivotally connected to the fixing elements 124 1nd 126. With an elongate member 80 retained in the clip element 128 as shown in dotted lines, pulling the wires 40 relative to each other in the directions as shown causes the elongate member 80 to tilt as indicated by the curved lines. Thus, the advertising strips 94 can be tilted to present their sign bearing surface viewable from in front of the screen 12 or a tilted orientation of the screen 12.

The display 12 as shown in FIG. 14 is formed of a number of side by side display panels 12. Corresponding elongate members 80 are connected together so that the pixels units 50 are in alignment. FIG. 20 shows a form of the connection arrangement 130 for connecting adjacent elongate members 80 of adjacent display panels 14. The connection arrangement 130 in FIG. 20 is in the shape of a coupling sleeve 131 configured to receive a portion of each of the facing ends of the adjacent elongate members 80 therein. As such, the coupling sleeve 131 has opposed sides 132 and 134, a slightly curved bottom 136, and a top 138 formed with shaped corners 140 and 142 for accommodating the flanges 112 and 110 of the elongate members 80. The coupling sleeves 131 are preferably clear or transparent.

Referring to FIG. 21, there is shown two of the vertically spaced elongated members 80 in four rotational positions being 0°, −35°, −55° and −70°. At 0° the angle of elevation is 20° from horizontal and the top section 92 and thereby the flange 112 is extending at this angle. The angle of rotation can be adjusted to suit viewers at various distances from the screen 12.

The form of the elongate members 80 shown in FIG. 21 is arranged for the members 80 to be pivotally rotatable at about their respective lower right corners at 90A. The members 80 are positioned so that at 0° their flanges 112 engage the top section of a respective lower member 80. Thereby, the flanges 112 serve as a stop member for limiting rotation to the position at −70° where the advertising information formed the top strips 94 is viewable.

The system 10 has a heat transfer arrangement for transferring heat generated within the elongate members 80 to the atmosphere. FIG. 22 shows one form of the heat transfer arrangement which comprises a heat sink element 144 of formed of a metallic strip or foil, and a number of metallic screws 148 which fix the element 144 to the rear wall 84 and are in engagement with a part of a conductive carrier 146 on the circuit board 120. The heat transfer arrangement thus transfers heat from within the hollows 84 in the members 80 to dissipate exteriorly thereof.

To minimise sway of the screen 12, the bus member 54 and the suspension wires 40 are fixed to sway limiting members 62 (one only shown in FIG. 23) that are secured to a wall or other structure of the building.

As described with reference to FIG. 12, the bus member 54 of each display panel 14 is arranged to receive power and control signals for powering and controlling the LEDs of the pixel units 50 to display images. In this embodiment, the control signals are preferably injected onto the power. As the pixel units 50 require DC power, the power fed along the bus member 54 is transformed to a lower DC voltage by a transforming circuit built into the control module of the each pixel unit 50. A filter circuit built into each of the control modules is arranged to filter the control signals from the power and the filtered control signals are then decoded by the decoding units built into the control module in the pixel units 50. The decoded signals then control luminance of the LEDs to form images. To this end, as shown in FIG. 24, a signal processing arrangement 70 is used to provide the power and the control signals to the bus members 54. The processing arrangement 70 includes a signal processing unit 76 arranged to generate video data signals from a video source 72. The generated video data signals are transmitted to panel control units 77 each of which is arranged to modulate the generated video data signals onto power. The bus members 54 carry the modulated video signals and power for delivery to the video control units 121 of the elongate members 80 in each display panel 14 for decoding thereof. The control modules 122 then control luminance of the LEDs according to the decoded video signals. The modulated video signals may be injected and filtered out on the bus member 54 or by discrete wires.

Referring to FIG. 25, the bus member 54 as shown is an insulated flat cable with multiple conductor groups 54A to 54D. Spaced insulation piercing connector assemblies 150 are arranged along the cable 54. The connector assemblies as shown more clearly in FIG. 26 are of a snap fitting type with a substantially U-shaped first component 152 adapted to receive the cable 54 and a compatibly shaped second component 154. The components 152 and 154 are arranged for snap fitting together with the cable 54 therebetween as shown in FIG. 27. For this purpose, the component 152 has a pair of hook elements 156 each extending from an upturned arm 152A (one only shown) and the second component 154 is formed with a pair of retention apertures (not shown) in its upturned arms 154A.

The second component 154 is also provided with piercing contacts 154B adapted for piecing the insulation layer(s) of the cable 54 to contact wires in the groups 54A to 54D. Shielding pieces 154C are provided to insulate and shield the contacts 154B.

The form of the elongate member 80 shown in FIG. 28 is in the form of a tube with each of its open ends terminated with a plastic clip 157 which are adapted to seal the ends, and provide slots 158 in an elongate extension 159 for the PCB connector. Since the tubes 80 are to be rotating with respect to the cable connector assemblies 150, they are not be physically restrained, rather a thin plastic protrusion 160 from the back of the tube connectors are provided to locate on the cable connector assemblies 150 as a tangent to provide the hinge for the movement (see FIG. 29).

A locating recess 162 (see FIG. 130) is formed in one of the end clips 157 and a spigot 164 on the opposite end clip 157. The clips 157 are arranged so that adjacent tubes 80 are located by locating the spigots 164 of tubes 80 in one panel 14 in the recesses 162 of corresponding tubes 80 of an adjacent panel 14. The recesses and the spigots thus serve to locate and align the tubes 80 and thereby maintaining translational and rotational accuracy.

Behind the recess/spigot there is a small magnet which locks onto the opposing magnetic field of the other tube and locates according to the recess and spigot. In this way, the arrays connect themselves as they are rolled off separate rolls to form a single screen, significantly reducing the amount of mechanical plugging and unplugging to commission and decommission a display for any particular event.

Referring to FIG. 31, the video signal processing arrangement 70 as shown has a panel control unit 77 for each panel 14 of the display screen 12. The panel control units 77 are connected in series as shown in FIG. 30. The leftmost control unit 77 is connected to a video processing unit 76 which receives audio and image data from a video source 72. The video processing unit 76 in this case has a number of digital video interface (DVI) 73 for providing digital video signals to multiple display systems 10. The panel control unit 77 is arranged to modulate the DVI signals and generate modulated video signals onto a modulated line 1 to which the tube control units 121 are connected. The processing arrangement 70 also has a serial line 2 connecting the control units 121 in series.

The control units 121 in this embodiment are each arranged to control a master tube 80 and a number of slave tubes 80.

A single DVI output from an interface 73 of the processing unit or PC 76 runs to the first roll panel control unit 77 which then passes signal on to the rest of the panel control units 77 in series. That is, the first roll gets the signal from the computer and passes it on to the second roll that takes its bit and passes it on to third roll 3 and so on.

In initialisation mode, the panel control unit 77 connects in serial sequentially to each tube (elongated members) control units 121 via the digital serial line 2. With this line the panel control unit 77 is able to establish the size of the segment or panel by a process of sequential activation, address initialisation and then entering pass through to completion of the initialisation process. This “process and pass” technique on the serial line also avoids long transmission line issues and aids in error checking. The panel control units 121 also connects to the tubes in a parallel bus fashion carrying modulated addressing and set up data. This data is passed to the tubes when the tube is active which is gated by the serial line status.

In operation mode, data is passed from the segment controller to the tube controllers on the modulated bus and controlled through a combination of addressing and round robin timing.

Each second tube contains a tube controller which also connects to and controls one or more slave tubes usually directly below the master tube. The tube control logic takes the data and controls the LEDs intensity through pulse width modulation in each tube and its associated slave tube. In this way the screen process and displays video.

The panel control unit 77 uses the digital line 2 to setup the addresses and order of the master tube control units 121. The QAM line 1 is then used for addressing each master tube control unit 121, and sending the data for the row through, followed by an error algorithm code. If the algorithm indicates an error in transmission then the master control unit 121 for the row will request the data again, and the panel controller 77 will send along the QAM line again. Once the master control unit 121 has a successful read, or a predetermined number of resends has been reached, the master control unit 121 returns to “pass up mode” to receive and regenerate signals from master control unit 121 below it to the panel controller 77 above it. The panel controller continues to the next master row.

The output of the master row control units 121 is a stream of bits which are clocked. across a shift register 3 and then latched to update the LEDs 51, a different stream of bits are clocked to the slave row 80 from the microprocessor 77 and again latched to update the slaves LEDs 51. Using a series of n-bit long pulse sequences, the output parallel data from the shift registers 3 realises a PWM solution to controlling the brightness of the n LEDs 51 individually.

On power up the tube master control units 121 all enter initialisation phase where they wait for an enablement signal. The panel control unit 77 activates first tube master control unit 121 by sending a signal on the serial link 2 which is received by the first tube. The first tube master control unit 121, now activated, receives instruction from the panel control unit 77 via the modulated signal line 1 with addressing details. In this first case the tube master control unit 77 is to accept pixels 1 through n where n is the number of pixels in the master and slave tubes 80.

The first tube control unit 121 on completion of addressing programming moves out of initialisation mode to pass through mode on the serial data line. The next addressing instruction received from the panel control unit 121 is passed down the serial data line 2 to the next tube master control unit 121 in initialisation mode. (Second tube). This process repeats until the control unit 121 at the end of the roll is initialised. When this controller goes to pass through mode the next initialisation being to a non existent controller returns an error on the modulated line or the controller times out.

In this way the panel control unit 77 (corner controller) establishes the length of the roll and the positioning of the pixels within while the tube master control units 121 are programmed to receive their applicable data. In this way the tubes are common and replacement is a matter of using a common spare tube.

The form of the panel control unit 77 shown in FIG. 32 has a demodulator 77A for receiving demodulating digital video signals from the digital video interface 73. A processor 77B processes the received DVI signals and stores an entire refresh in temporary memory 77C for encoding and constructing the intensities and encoded signals for the master control units 121 or row controllers. The processor 77B then computes addressing signals and video control signals for the row controllers 121. The video control signals are then subject to a digital to analogue conversion process at 77D, then modulation (quadrature modulation QAM) and amplification respectively at 77E and 77F before passing to the row controllers 121. The Digital Serial link with the signals subject to voltage driving at 77G passes through the row controllers 121, while the modulated QAM signal is connected in parallel. This dual link ensures that row controllers are distinguishable, while still able to communicate to row controllers past a discontinuity in the serial line. During operation the row and controllers interact to setup their positions through an initialisation sequence.

Referring to FIG. 33, the row controllers 121 has QAM de-modulator 121A and an analogue to digital converter 121B for demodulating and converting the QAM signals from the panel controller 77. The converted QAM signals are the processed by a processor 121C and retained in a buffer 121 D until instructed to pass t the LEDs.

The operation of the signal hierarchy is divided into two areas:
1. Initialisation

Initialisation is performed to give each row controller 121 a relative, temporary address in the array. This is needed because elements are not provided a non-volatile unique ROM address. Initialisation is performed on power-up, upon request, and at designated intervals to ensure synchronisation.
2. Continued Refreshing

Separate to the initialisation mode, where all row controllers 121 have stored their temporary address for the session and are now only concerned with refreshing the display.

The first process of the panel controllers 77, on power-up of the display, is to commence the initialisation sequence. The aim of initialisation is to ‘flash’ the RAM of each row controller 121 with an address, and a duplicate number. The address consists of a 6 bit binary number, (single 64-QAM symbol), however is not be unique due to the number of row controllers connected. The duplicates are arranged to only examine the address line after they have observed the correct number of duplicates, hence the combination of duplicate number and address are the only necessary components for a row controller to be uniquely accessed.

The modulated signal line is shared by colour information, addresses and interrupt codes. To differentiate between the colour information and addresses, the addresses will be distinguished by using a ‘clock synchronisation’ method for a specified amount of time. To be able to interrupt Row controllers, interrupt addresses will be reserved. Such as:

000000B Not a possibility due to ‘clock synchronisation’ 50 method

111111B To signal a critical error

101010B To signal the start of an initialisation

Due to the signalling method of the array devised, if the next input frame is identical to the previous, then the data need not be sent at all, without compromising the synchronisation of the display. This is used to reduce ‘shimmering’ in static advertisements, however can also be utilised as a user function, to allow the selection of different hardware input streams, without static appearing on the display.

The following is a step by step guide to the initialisation process proposed to provide each Row Controller with an address and timer value. FIGS. 34 to 41 show status of the links and modes of the first three row controllers 121.

### Step 0: Begin Initialisation (FIG. 34)

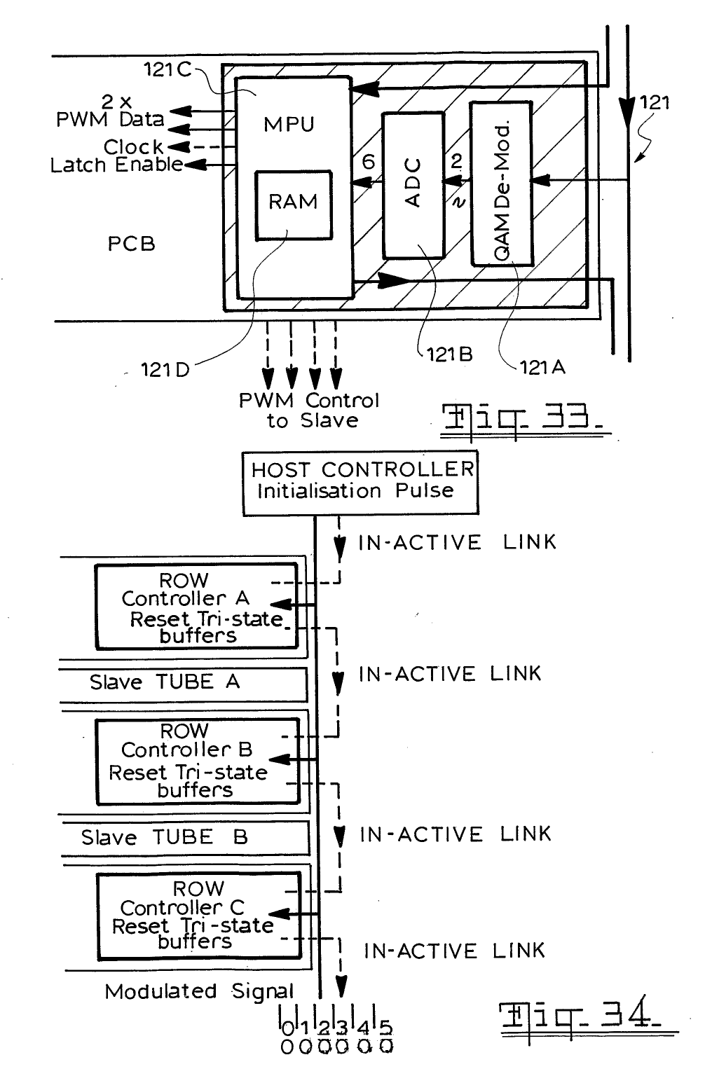

To begin initialisation, the panel controller 77 uses the reserved code (I0 I1 I2 I3 I4 I5, ‘I’ represents Initialisation) on the modulated line activating initialisation mode in the row controllers 121. The code will be left active on the modulated line for a minimum specified period denoted as Iw (Width of initialisation pulse) to ensure the processors do not enter initialisation state upon receipt of the same code in colour information. In this mode all tri-state buffers are reset to look at the serial input directly above. FIG. 35 shows the states of the row controller 121, panel controller 77 and link states at this instant in time.

### Step 1: for Controller A (FIG. 35)

The panel controller places the address for Controller A on the modulated line using ‘clock synchronisation’ and a high on the serial link. Row controller A on receipt of the serial high, examines the modulated line, and stores the address. After Aw (Width of address pulse) periods the panel controller sends 256 QAM symbols containing colour information. This will occur 3 times with exactly the same data, Aw pulses of address, followed by 256 symbols of data. This is a ‘practice refresh’ where the host controller initialises all the rows in the array one by one, while each row counts the number of similarly addressed rows present in the array, between activation signals.

### Step 2: for Controller A (FIG. 36)

As soon as the first data symbol is sent, the panel controller will hold the serial link low. The row controller receives this and changes its tri-state buffer to output. After a period of low both tri-state buffers on the first serial link will be changed.

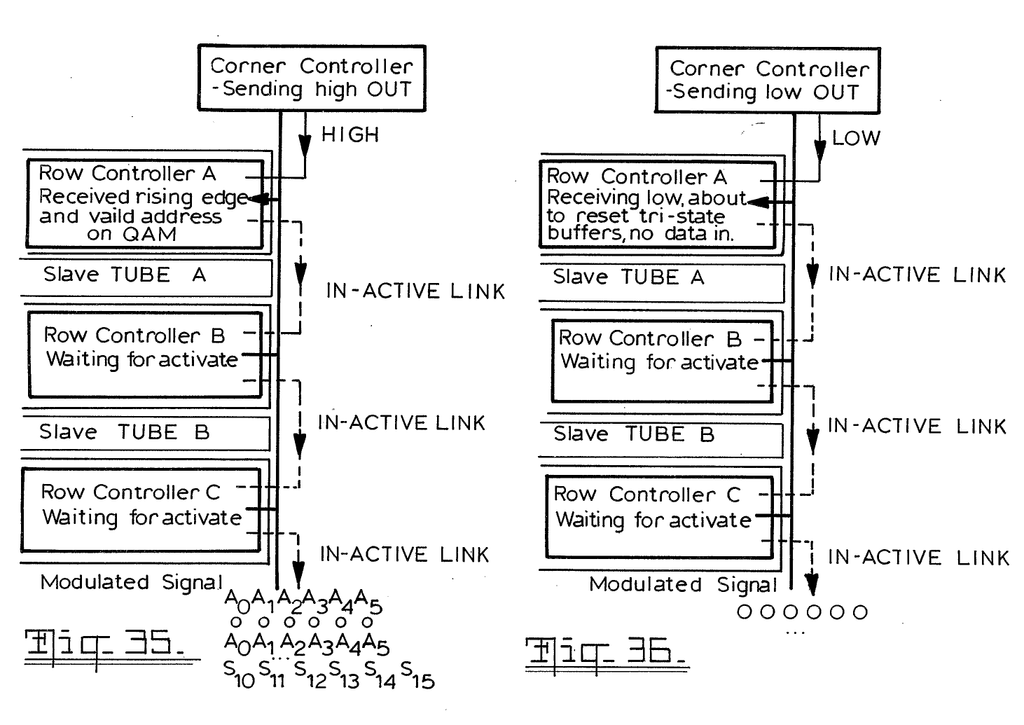

### Step 3: for Controller A (FIG. 37)

Once the data has been received a high will be returned to the panel controller, from row controller A, signalling to the panel controller that it has successfully received data and the panel controller may now continue to the subsequent row. The panel controller sets the address for row controller B, and row controller A begins to examine the modulated line for similarly addressed rows.

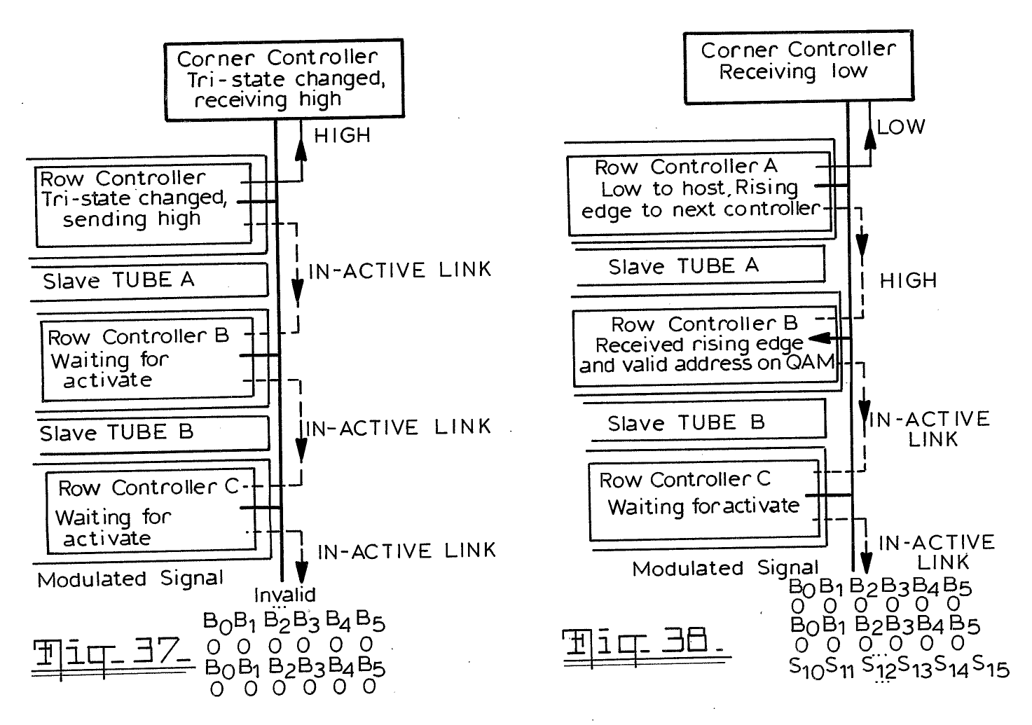

### Step 1: for Controller B (FIG. 38)

After a short high, Row Controller A will send a low to the Corner Controller and a high to Row Controller B. The delay between the low to the Corner Controller to change the address and the high to the next Row Controller, ensures that the address is valid for the next Row Controller.

### Step 2: for Controller B (FIG. 39)

Upon receipt of the rising edge from row controller A, row controller B will examine the modulated line, store the address and start an internal timer. Row controller A will transmit a ‘low’ to row controller B, signalling the reverse of the tri-state buffers, however a high will not be transmitted back to the panel controller until row controller B has received all its data.

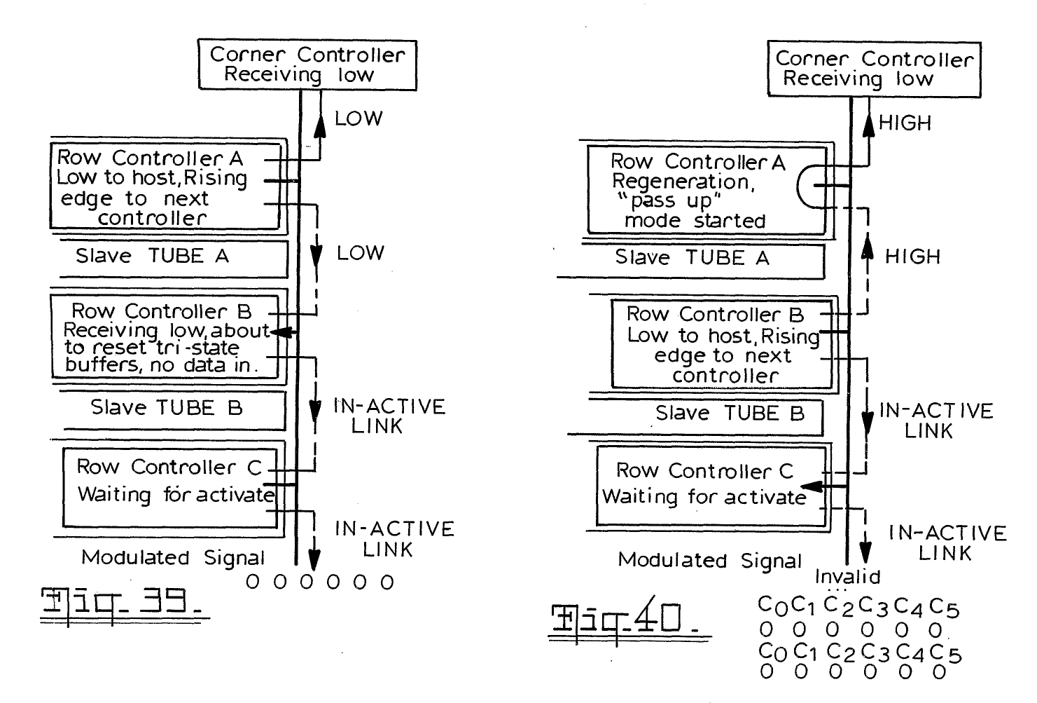

### Step 3: for Controller B (FIG. 40)

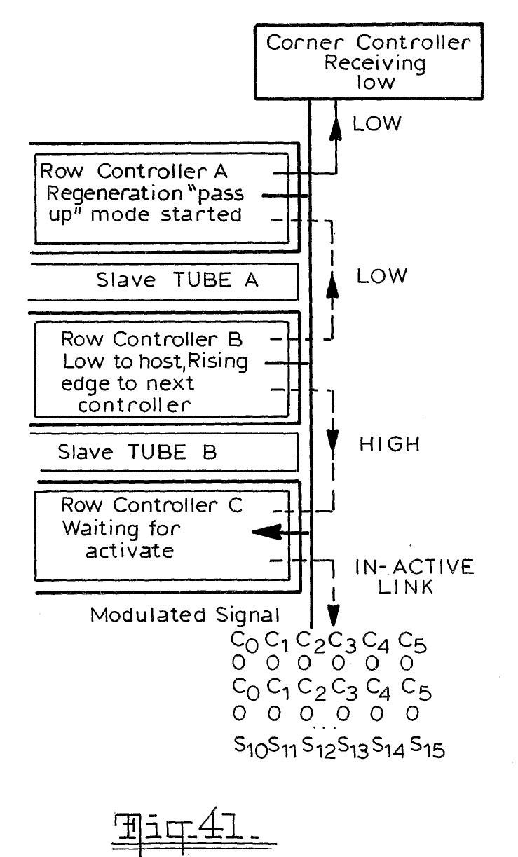

When row controller A resets its tri-state buffers it effectively connects the input from the controller below to the output above. The row controller has entered ‘Pass through’ mode. Note that in FIG. 41 he high transmitted to the panel controller indicating that this is activated by row controller B and passed on by row controller A. This will be the second high the panel controllers has received indicating that two rows are correctly connected and addressed.

### Step 1: for Controller C (FIG. 41)

Row controller B sends a low to the host, and a rising edge on to row controller C, now also examining the modulated line for similar addresses. Operating exactly the same as the others, row controller C examines the modulated line and store the address.

### Subsequent Steps

The panel or host controller will continue to receive pulses back from Row Controller A as it transmits the pulses of the Row Controllers from the array as they are activated. In this fashion the panel or Corner Controller can count exactly how many rows are connected, and compare this against the preset number of rows, determined prior to start up via dip switches on the Corner Controller. Significant difference in the expected and counted rows indicates a failure. The Corner Controller will report the error, and power down the array to protect the Controllers if a short circuit has occurred. If the correct number of rows have responded, and the host controller has received no more pulses from the array, the host controller will use the initialise pulse (I0 I1 I2 I3 I4 I5) in ‘clock synchronisation’ to signal the second half of the initialisation sequence. The Row Controllers upon receipt of the initialisation pulse will reverse the tristate buffers to down mode, and wait for activation from the Row Controller above. The Row Controllers, once provided an address, have been examining the modulated line for duplicate signals of their address. Each time a duplicate is observed, without the activation signal available, a counter is incremented.

When the serial line is activated, and the address becomes valid, the counter is stored to memory.

The counter value represents the number of duplicate addresses present in the array. The value will range depending on how many rows are present, indicating how many addresses the row controller should ignore, before reading the data off the modulated line.

This ‘address and duplicates’ technique minimises the number of addresses needed, without having any prior information stored about the rows position in the array. That is, that any physical row can be placed any where in the array, without prior addressing. This embodies the solution requirement of universal rows.

### Continued Refreshing

After the second initialisation pulse and second activation signal from the preceding Row Controller, every tri-state buffer, address, and counter value is set correctly to begin refreshing immediately. This does not however, need to start instantly. The data provided by the corner controller during initialisation will be a promotional/diagnostic image that can be held for as long as necessary. Once a frame has been buffered into the Corner Controller and processed into LED intensities, the first address will be placed on the modulated line, followed by 256×2 symbols of data (for master and slave rows). Following the data, will be a ‘check-sum’, a common error detection algorithm which the Row Controller will compare against the check-sum of the received data, and determine if the transmission was accurate.

If the transmission was accurate the serial line will be pulsed high for a length of time by the Row Controller, signalling success to the Corner Controller. If the data was corrupt, then a pattern will be transmitted, requesting the data again. In which case, the Corner Controller will resend the address and data in its entirety.

The next row of duplicate address will not respond to the resent data train, because a pre-set time out value will ensure that an address can not be counted twice when appearing directly after a similar address.

For each duplicate—not including resends—that a row observes, it decrements its duplicate counter. Upon reaching zero it is clear that the next identical address, on the modulated line will be followed by data that was intended for that row. Upon receipt of the data, the counter is restored to its value and the Row Controller returns to examining the modulated line until the next time the counter reaches zero, i.e. the next refresh.

Every row is performing this task sequence, offset from one another by address and duplicate counter, which ensures that only a single row is active at any one time.

### Protocol Characteristics

The protocol used in signal propagation through the array provides some advantages to diagnostics and signal reduction.

### Signal Reduction

Should the Corner Controller realise that the next frame is identical to the previous, it can pause data transmission by ceasing to transmit addresses on the modulated line. The counter values will not decrement unless duplicate addresses are observed and hence the screen will hold the currently displayed image until the next frame is successfully transmitted. The asynchronous nature of the display means that the refresh rate can be dynamically varied to suit the input. The slower the refresh rate, the slower the data speed of the modulated signal, and the more reliable the transmission.

### Failure Modes

Should any row controller fail, the Corner Controller will continue to transmit the data intended for the row, such that other similarly addressed rows remain synchronised. The Corner Controller may try to initialise the display again to attempt to re-connect with the missing row, otherwise the screen will continue without fault. This implies that small connection problems do not disproportionately affect the display operation.

Given that each row should respond with ‘success’ or ‘fail’ at the end of each data stream, the Corner Controller will be able to report exactly which row failed and when. If the serial link has failed, the Corner Controller will default to sending each set of data three times.

If a row has not received data correctly for the last n frames, then this could indicate a failure of the modulated link. Several link failures or a complete disconnection in the signal cable will isolate one or more rows completely form the Corner Controller. The rows below the discontinuity will not continue to update, rather continuing to display prior refreshes. Possible measures could be taken, such as load measurement, to determine if the modulated cable has been disconnected. Signal protocol is not enough to accurately diagnose modulation link failure.

### Safe Power Down

The state of the display can not be reliably determined after a power shortage. For this reason, the display will always commence the initialisation sequence upon power up to correctly setup the screen and reset the states of all row controllers. Safe power down should be performed by disconnecting the DVI input to the screen. This will force a static promotional image on the display, and unless reconnected, the Corner Controller will have no further input. During this time, the row decoders will not be processing data, and hence can be powered down safely.

Whilst the above has been given by way of illustrative example of the present invention many variations and modifications thereto will be apparent to those skilled in the art without departing from the broad ambit and scope of the invention as herein set forth in the following claims.

1. A large scale display system for displaying images, the system comprises a display screen formed of one or more display panels, the or each said display panel having at least one display segment formed of spaced elongate members, each elongate member having a conductive carrier supported therein and spaced controllable pixel units mounted on said conductive carrier, the pixel units in the elongate members being arranged to form a matrix of pixels; a bus member arranged along one edge of the display screen, or along one or each of the opposed edges of the or each said display panel for conveying power and/or video data signals to said carriers; the bus member of the or each said display screen or panel being in communication with a panel control unit arranged to supply said power and/or video data signals to the bus member(s) of the or each panel/segment for controllably energising said pixel units thereof to thereby controlling luminance of the pixels.

2. The system according to claim 1 wherein each elongate member has a video control unit arranged to, in response to the video data signals, controllably energise said pixel units therein.

3. The system according to claim 1 wherein the elongate members are arranged in at least one group of linked elongate members, and one of the linked elongate member in the or each group has a video control unit arranged to, in response to the video data signals, controllably energise said pixel units in the linked elongate members.

4. The system according to claim 1 wherein said panel control unit(s) is configured to receive video signals from a video source and to transform the received video signals into modulated video data signals for conveying to the bus member(s).

5. The system according to claim 4 wherein the video data signals being superimposed on power for the pixel units.

6. The system according to claim 1 wherein the panel control unit(s) having an initialisation arrangement for initialising the video control units in the elongate members to respond to the video data signals with corresponding addresses allocated to the elongate members.

7. The system according to claim 6 wherein the initialisation arrangement is configured to determine screen or panel pixel size in accordance to the allocated addresses.

8. The system according to claim 1 further comprising a suspension arrangement for suspending said elongate members in a vertically or horizontally spaced direction, the suspension arrangement having said one or more bus member(s) and/or one or more suspension lines extending along the or each said display panel.

9. The system according to claim 8 wherein the bus member(s)/suspension lines are relatively flexible in a manner to allow the display panels to be foldable or rollable.

10. The system according to claim 8 wherein the elongate members are adapted to be pivotally movable and further comprising a controllable driving arrangement for driving said elongate members to pivotally move between two orientations, one being for viewing images formed by the illuminance of the LEDs and the second being for viewing static information formed on the elongate members.

11. The system according to claim 8 wherein each said bus member and/or each said suspension line is associated with a plurality retention clips, each of which being configured to retain an elongate member received therein.

12. The system according to claim 11 wherein the clips are arranged to be pivotally movable so that orientation of the elongate members can be selectively positioned.

13. The system according to claim 1 wherein the display screen is formed of two or more of said display panels arranged side by side, and adjacent display segments of the side by side display panels are arranged to be interconnectable.

14. The system according to claim 13 wherein the elongate members be formed or provided with end flanges shaped so that one end of each elongate member in a display panel can be interconnected with an adjacent end of a corresponding elongate member in an adjacent display panel.

15. The system according to claim 13 further comprising coupling members, each coupling member being adapted to interconnect adjacent ends of corresponding tubular members in side by side display panels.

16. The system according to claim 1 wherein the conductive carrier in each elongate member being formed of a flexible or rigid material.

17. The system according to claim 16 wherein the conductive carrier is formed as a circuit board having one or more control circuit modules for the corresponding pixel units.

18. The system according to claim 16 wherein the bus member(s) are arranged to carry control signals so that the control circuit modules on the conductive carriers connected thereto can control luminance of the LEDs in accordance with the control signals.

19. The system according to claim 17 wherein the bus member(s) being arranged to carry an AC power source injected with control signals for the pixel units, and the control circuit modules are arranged to transform the AC power source into a DC power source for use by the pixel units to energise the LEDs, and to filter the control signals for controlling luminance of the LEDs.

20. The system according to claim 1 further comprising a heat transfer arrangement adapted to transfer heat from the conductive carrier in each elongate member to exterior thereof.

21. The system according to claim 20 wherein the heat transfer arrangement has a heat sink element fixed to each elongate member and one or more fixing elements made of a heat conductive material are adapted to fix the heat sink element to the associated elongate member and to transfer heat from said conductive carrier to the heat sink element.

22. The system according to claim 1 wherein each elongate member being formed with a hollow extending therethrough and bounded by a base, a rear wall, an open front or substantially transparent front wall, and a top section. The conductive carrier is mounted in the hollow and the pixel units are arranged for the LEDs to be facing said an open front or substantially transparent front wall.

23. The system according to claim 22 wherein the pixel units are positioned so that the LEDs are at a distance from said an open front or substantially transparent front wall to limit direct sunlight on the LEDs.

24. The system according to claim 22 wherein the elongate members each having a sun shield adapted to substantially shield the LEDs in said hollow.

25. The system according to claim 22 wherein the top section of each elongate member may have a top plate arranged to be removable and bearing a part of a static printed information.

26. The system according to claim 25 wherein the top section of each elongate member is formed with facing grooves for removably receiving its top plate.

27. The system according to claim 1 further comprising an electrical connection arrangement having connector assemblies spacedly fixed the or each bus member and the connector assemblies are adapted for connection to respective conductive carriers in the elongate members.

28. The system according to claim 27 wherein said connector assemblies are of an insulation piercing type having conductor elements arranged to penetrate into an insulation about the bus member(s).

29. The system according to claim 28 wherein the bus member(s) are of a flat insulated cable with wire groups therein and the conductor elements are adapted to contact the wire groups when pierced through the insulation.

30. The system according to claim 1 wherein the or each said display panel has a plurality of display segments arranged in an array, and adjacent display segments in said array are mechanically and/or electrically connected to each other.

31. The system according to claim 1 wherein the display screen having a top, a bottom and opposed sides, and the bus member is arranged along either the top or bottom, or one of the opposed sides.

32. The system according to claim 1 further comprising a decoding arrangement for decoding control signals for the pixels into decoded signals and the decoding arrangement is arranged to provide the decoded signals to control said luminance of the pixels.

33. The system according to claim 32 wherein the decoding arrangement includes a decoder for each elongate member.

34. The system according to claim 1 wherein each of the pixel units having one or more controllable light emitting diodes (LEDs) in a single or multiple colours.

35. The system according to claim 34 wherein each said pixel unit has a red LED, a green LED and a blue LED, and the processor unit is arranged to produce control signals that can control the LEDs in the pixel units to produce luminance over a substantially full range of colour spectrum.

36. The system according to claim 1 further comprising a sway restraining arrangement for limiting sway of said display screen.

37. The system according to claim 36 wherein the sway restraining arrangement having a number of spaced release able securing members for securing the display screen to a support structure.

38. The system according to claim 1 further comprising a support arrangement for supporting said display screen on a support structure, the support arrangement including a set of brackets configured to be releaseably fixed to the support structure and to support the top of the or each unfolded or unrolled display panel of the display screen.

39. The system according to claim 38 wherein the or each display panel having its top fixed to a roll and the support arrangement having a spindle extending through the roll or rolls and arranged to turn said roll(s) so the display panel(s) can be retracted on said roll(s) for storage or transportation, and extended during use.

40. The system according to claim 39 wherein a drive arrangement is associated with the spindle to facilitate turning of said roll(s), and the drive arrangement having a controllable electric motor coupled to drive said spindle.

41. The system according to claim 1 wherein the top, bottom and the opposed sides of the display screen being shaped to conform to a particular shape of the support structure.

42. The system according to claim 1 wherein the pixel units are arranged to form a pixel pitch ranging from about 25 mm to about 100 mm depending on expected viewing distance.

43. A large scale display system for displaying images, the system comprises a display screen formed of one or more foldable or rollable display panels, the or each said display panel having at least one display segment formed of intersecting conductive wires arranged in a matrix of rows and columns, and spaced pixel units supported by one or more of the wires in said rows or columns, or by one or more support lines extending along the or each said display panel, and the spaced pixel units being arranged to be controllably energisable pixels; a bus member arranged along one edge of the display screen or along one edge of the or each said display panel for conveying power and/or control signals to said wires; and a panel control unit provided for the or each said display panel and arranged to supply said control signals to the bus member(s) for controlling luminance of the pixels, said panel control unit(s) being configured to receive video signals from a video source and to transform the received video signals into modulated video data signals for conveying to the bus member(s) and having an initialisation arrangement for initialising the pixel units to respond to video data signals with corresponding addresses allocated to the pixel units.
